(19) United States
(12) Patent Application Publication
(10) Pub. No.: US 2025/0373480 A1
(43) Pub. Date: Dec. 4, 2025

(54) System and Method of Compensating for Phase Discontinuity in a Radio Network

(71) Applicant: Benetel Ltd., Dublin 8 (IE)

(72) Inventors: Pooria VARAHRAM, Dublin (IE); John Doyle, Dublin (IE)

(21) Appl. No.: 19/214,303

(22) Filed: May 21, 2025

Related U.S. Application Data
(60) Provisional application No. 63/652,479, filed on May 28, 2024.

(51) Int. Cl. H04L 27/26

(52) U.S. Cl. CPC H04L 27/2697; H04L 27/26035; H04L 27/2607

(57) ABSTRACT

Systems and methods for phase pre-compensation in OFDM radio modules include converting a generic phase vector of floating-point phase values into a hardware-ready phase vector of unsigned fixed-point coefficients. A processing system selects a bit-precision value N, confines each phase remainder to a modulus range exceeding −π and not exceeding +π, scales by 2^{(N-3)}, rounds to a nearest integer, and adds 2^{N} to negative results, thereby producing the coefficients. The system may store the coefficients in contiguous memory addresses so that a vector-rotation circuit may generate cosine and sine pairs within one hardware clock cycle and multiply each OFDM symbol to yield phase-continuous transmit or receive data.

### RELATED APPLICATIONS

This application claims the benefit of priority to U.S. Provisional Patent Application No. 63/652,479 entitled “System and Method of Compensating for Phase Discontinuity in a Radio Network” filed on May 28, 2024, the entire contents of which are hereby incorporated by reference for all purposes.

### BACKGROUND

Nationwide commercial wireless networks have experienced phenomenal growth and capabilities in recent years. The most popular of these networks have been designed and developed by a standards body known as 3GPP. The fifth generation of these networks (i.e., 5G networks) are currently deployed in many countries, and work is already underway on the sixth generation of networks (i.e., 6G networks). Each of these generations provides faster speeds, greater bandwidth, and more services. In parallel with these network advancements, people are using their mobile devices to consume more services, which in turn results in more data being sent on these networks. Further, there are more non-phone devices consuming these services as part of the new connected world. As such, the technology used to build commercial wireless networks has needed to constantly evolve in order to satisfy the increased number of mobile devices consuming a greater number of services.

### SUMMARY

Various aspects include methods of phase pre-compensation, performed by at least one processor of a processing system in a radio device, which may include receiving a generic phase vector that contains floating-point phase values, selecting a bit-precision value N that defines a target fixed-point numeric format, for each phase value in the generic phase vector, computing a remainder of the phase value mod 2π to map the phase value to an interval greater than −π and less than or equal to +π, multiplying the remainder by 2^{(N-3)} to obtain a scaled phase value, rounding the scaled phase value to a nearest integer to obtain a rounded phase value, and adding 2^{N} to produce an unsigned fixed-point coefficient in response to determining that the rounded phase value is negative, and writing each unsigned fixed-point coefficient to successive memory locations to form a hardware-ready phase vector directly addressable by a vector-rotation circuit. In some aspects, computing the remainder of the phase value mod 2π to map the phase value to an interval greater than −π and less than or equal to +π further may include subtracting 2π before multiplying the remainder by 2^{(N-3)} to obtain the scaled phase value in response to determining that the remainder exceeds π.

Some aspects may further include formatting the unsigned fixed-point coefficient as a hexadecimal string and replacing the corresponding floating-point element in the generic phase vector with the hexadecimal string before writing each unsigned fixed-point coefficient to successive memory locations that together form the hardware-ready phase vector directly addressable by the vector-rotation circuit. Some aspects may further include selecting the bit-precision value N from a set that may include 8, 12, 16, and 32 according to a capability of a reconfigurable hardware platform associated with the vector-rotation circuit. In some aspects, the operations of receiving the generic phase vector, selecting the bit-precision value N, and writing each unsigned fixed-point coefficient to successive memory locations are performed during an initialization interval that precedes base-band data transmission or reception.

Some aspects may further include repeating the operations of receiving the generic phase vector, selecting the bit-precision value N, and writing each unsigned fixed-point coefficient to successive memory locations for each sub-carrier-spacing parameter in a plurality of sub-carrier-spacing parameters and storing a corresponding hardware-ready phase vector for each sub-carrier-spacing parameter in the memory. In some aspects, multiplying the remainder by 2^{(N-3)} to obtain the scaled phase value may include left-shifting the remainder by (N−3) fractional bits in a hardware multiplier that accepts floating-point input and outputs fixed-point format. Some aspects may further include for each OFDM symbol to be transmitted selecting a fixed-point coefficient from the hardware-ready phase vector, generating by the vector-rotation circuit a corresponding cosine value and sine value within one hardware clock cycle, and multiplying the OFDM symbol by the cosine and sine values to produce a phase-compensated OFDM symbol for transmission, in which successive phase-compensated OFDM symbols exhibit continuous phase transitions across symbol boundaries.

Further aspects may include a phase-vector quantizer circuit arranged to provide the functions corresponding to the operations of the methods discussed above. Further aspects may include a computing device having a processor configured with processor-executable instructions to perform various operations corresponding to the methods discussed above. Further aspects may include a computing device having various means for performing functions corresponding to the method operations discussed above. Further aspects may include a non-transitory processor-readable storage medium having stored thereon processor-executable instructions configured to cause a processor to perform various operations corresponding to the method operations discussed above.

### BRIEF DESCRIPTION OF THE DRAWINGS

The accompanying drawings, which are incorporated herein and constitute part of this specification, illustrate exemplary aspects of the invention, and together with the general description given above and the detailed description given below, serve to explain the features of the invention.

FIG. 1 is an architectural diagram illustrating network components of an example communication system suitable for use with various embodiments.

FIG. 2 is a block diagram illustrating the internal components of a radio module suitable for use with various embodiments.

FIGS. 3A and 3B are block diagrams illustrating the internal components of a phase pre-compensation block and a phase compensation block respectively that may be found within a radio module suitable for use with various embodiments.

FIGS. 4A and 4B are process flow diagrams illustrating a method of calculating a phase compensated output signal in accordance with some embodiments.

FIG. 5 is a process flow diagram illustrating a method of creating and populating an OFDM symbol table in accordance with some embodiments.

FIG. 6 is a block diagram that illustrates a table including OFDM symbols and the corresponding end times of the OFDM symbols according to an example embodiment.

FIG. 7 is a process flow diagram illustrating a method of creating phase-vectors in accordance with some embodiments.

FIG. 8 is a process flow diagram illustrating a method of creating a generic phase-vector in accordance with some embodiments.

FIG. 9 is a process flow diagram illustrating a method of updating a generic phase-vector for a specific hardware platform in accordance with some embodiments.

FIG. 10 is block diagram illustrating an example on-chip system (SOC) suitable for implementing some embodiments.

FIG. 11 is a component block diagram illustrating an example computing device in the form of a smartphone that is suitable for implementing some embodiments.

FIG. 12 is a component diagram of a server suitable for implementing some embodiments.

### DETAILED DESCRIPTION

The various embodiments may be described in detail with reference to the accompanying drawings. Wherever possible, the same reference numbers may be used throughout the drawings to refer to the same or like parts. References made to particular examples and implementations are for illustrative purposes and are not intended to limit the scope of the invention or the claims.

In overview, some embodiments include methods, systems, devices, circuits, and/or components configured to address phase discontinuity in radio networks and are particularly beneficial within the context of advanced wireless communication standards such as 5G and upcoming 6G networks. In recent years, the increasing demand for high-speed data services has led to the development of advanced networks that offer greater bandwidth and faster speeds. However, technical challenges arise when older or less sophisticated devices are unable to process the wider bandwidths of these networks (older or bandwidth-limited user equipment processes narrower slices). One solution is to use a “bandwidth part” (BWP) segmentation that partitions the total bandwidth into smaller segments manageable by these older or bandwidth-limited devices. However, even with BWP, the base-station transmitter (gNB) may use a single center frequency that introduces a symbol-wise phase progression inside every bandwidth-part slice. That progression may corrupt demodulation, trigger phase discontinuity, and lead to decoding errors in the received signal.

The embodiments include components configured to compensate for phase discontinuity by introducing phase compensation in the digital domain (rather than the more complex radio domain). In some embodiments the components may calculate a phase vector that reflects the gNB center frequency and OFDM symbol timing. The components may receive the center-frequency parameter and sub-carrier spacing, create the phase vector, determine the current OFDM symbol, determine sine and cosine values, apply those values, perform quantization to quantize the results and create the output signal, and send the output signal to downstream elements. Phase rotation may occur in either domain; a preferred path applies the rotation after cyclic-prefix insertion in the transmitter and after cyclic-prefix removal in the receiver. The embodiments may reduce latency and complexity so that the compensation process operates more efficiently and consumes less power. As such, these embodiments provide a technical solution that improves the reliability and efficiency of data transmissions in wideband networks.

In the various embodiments, the methods described herein may be used to provide a low complexity and low latency solution to compensate the phase discontinuity in 5G NR OFDM symbols. The methods described herein may be implemented in base stations radios (e.g., 5G gNBs) and, or mobile devices (e.g., 5G UEs). An advantage of the low complexity of the methods described herein is that they may consume less power when implemented compared to previous methods.

In the various embodiments, the methods described herein may be independent of the range of frequencies being used. Further, the methods described herein may provide a universal solution and that works for all frequencies within a 5G NR numerology (e.g., FR1, FR2). Other improvements to performance and functioning of computing devices will be evident from the disclosures below.

The word “exemplary” is used herein to mean “serving as an example, instance, or illustration.” Any implementation described herein as “exemplary” is not necessarily to be construed as preferred or advantageous over other implementations.

The term “computing device” may be used herein to refer to any device that includes at least one programmable processor, a memory, and communication circuitry for exchanging data with a radio-access network (RAN). Examples include network-infrastructure nodes (e.g., next-generation Node B (gNB) platforms, small-cell boards, 5G radio units, O-RAN radio units, distributed units, relays, repeaters, integrated access-and-backhaul nodes), laboratory systems (e.g., conformance test sets, channel emulators, protocol simulators), stand-alone communication modules (e.g., cellular modems, modem modules that attach to enterprise routers or gateways, pluggable radio front-end cards, software-defined-radio dongles, system-on-chip packages that embed radio functions), customer-premises equipment (e.g., fixed wireless terminals, residential gateways, edge-computing appliances), specialized endpoints (e.g., Internet-of-Things sensors, asset trackers, industrial monitoring nodes, autonomous-machine controllers, robotic control links), personal-computing devices (e.g., mobile devices, wireless devices, smartphones, tablets, portable 5G laptops, desktops, rack-mounted servers, user-equipment platforms that integrate dedicated baseband subsystems), and non-terrestrial-network payloads (e.g., satellite transceivers, stratospheric or airborne communication modules, high-altitude platform relays). Each device may include a programmable processor, memory, and communication circuitry configured to implement the functionality described herein.

The terms “mobile device,” “wireless device” and “user equipment (UE)” may be used interchangeably and refer to any device that sends and receives wireless communication signals. Examples include handheld communication devices (e.g., cellular telephones, smart phones, voice-over-IP handsets), portable computing devices (e.g., tablet computers, laptop computers, palm-top computers, smart books, personal data assistants), consumer-premises equipment (e.g., residential gateways, routers, modems, network switches that incorporate wireless interfaces, streaming media players, smart televisions, digital video recorders, wireless gaming controllers, personal multimedia players), personal computers (e.g., desktop systems and rack-mounted systems that feature wireless adapters), and embedded nodes (e.g., machine-to-machine transceivers, Internet-of-Things modules). Each device may include a programmable processor, memory, and radio circuitry that provide the described functionality. In some embodiments, the wireless device may be a cellular handheld device that communicates through a cellular telephone network.

The term “bandwidth part” (BWP) may be used herein to refer to a technique that partitions an available channel bandwidth into smaller segments. This segmentation allows devices with limited bandwidth capability to operate within a network that supports wider channels. Allocating BWP segments to different devices permits older or simplified equipment to maintain communication while full-bandwidth devices remain unaffected. BWP affects baseband resource assignment and does not alter the radio-frequency carrier.

Wireless communication systems deliver services such as telephony, video, data, messaging, and broadcast. These systems may employ multiple-access technologies that share resources among users, including code-division multiple access (CDMA), time-division multiple access (TDMA), frequency-division multiple access (FDMA), orthogonal frequency-division multiple (OFDM), orthogonal frequency-division multiple access (OFDMA), single-carrier frequency-division multiple access (SC-FDMA), and time-division synchronous CDMA (TD-SCDMA).

Some embodiments may be implemented in or may operate in any network that provides broadband Internet or IP services, including both wired and wireless segments. Examples of wired technologies include active Ethernet, asymmetric digital subscriber line (ADSL), cable, data over cable service interface specification (DOCSIS), enhanced ADSL (ADSL2+), Ethernet, fiber-optic links, fiber-to-the-x (FTTx), hybrid-fiber-cable (HFC), local-area networks (LAN), metropolitan-area networks (MAN), passive optical networks (PON), satellite links, wide-area networks (WAN), and 10 Gigabit symmetrical passive optical networks (XGS-PON). Examples of wireless technologies include third-generation (3G), 3GPP, 3GSM, fourth-generation (4G), fifth-generation (5G), sixth-generation (6G), advanced mobile phone system (AMPS), Bluetooth®, cdmaOne, CDMA2000, digital enhanced cordless telecommunications (DECT), digital AMPS (IS-136/TDMA), enhanced data rates for GSM evolution (EDGE), evolution-data optimized (EV-DO), general packet radio service (GPRS), global system for mobile communications (GSM), high-speed downlink packet access (HSDPA), integrated digital enhanced network (iDEN), land mobile radio (LMR), long-term evolution (LTE), low-earth-orbit (LEO) satellite Internet, massive multiple-input multiple-output (MIMO), millimeter-wave (mmWave), new radio (NR), next-generation wireless systems (NGWS), universal mobile telecommunications system (UMTS), Wi-Fi 7 (IEEE 802.11be), Wi-Fi Protected Access (WPA, WPA2), wireless local-area networks (WLAN), and worldwide interoperability for microwave access (WiMAX). Each technology includes transmission, reception, signaling exchange, and content delivery functions. The references above serve illustrative purposes and do not restrict claim scope. It should be understood that, while specific technologies and standards are described herein to exemplify the range of capabilities associated with a service provider network, these references and details are included to serve merely as illustrative examples. These references should not be construed as narrowing the scope of the claims to any particular communication system or technology unless specifically recited in the claim language.

The term “processing system” may be used herein to refer to one or more processors, including multi-core processors, that perform computing functions described herein.

The term “system on chip” (SoC) may be used herein to refer to a single integrated circuit (IC) chip that includes multiple resources or independent processors integrated on a single substrate. A single SoC may include circuitry for digital, analog, mixed-signal, and radio-frequency functions. A single SoC may include a processing system that includes any number of general-purpose or specialized processors (e.g., network processors, digital signal processors, modem processors, video processors, etc.), memory blocks (e.g., ROM, RAM, Flash, etc.), and resources (e.g., timers, voltage regulators, oscillators, etc.). For example, an SoC may include an applications processor that operates as the SoC's main processor, central processing unit (CPU), microprocessor unit (MPU), arithmetic logic unit (ALU), etc. An SoC processing system may also include software for controlling integrated resources and processors, as well as for controlling peripheral devices.

The term “system in a package” (SIP) may be used herein to refer to a single module or package that contains multiple resources, computational units, cores, or processors on two or more IC chips, substrates, or SoCs. For example, a SIP may include a single substrate on which multiple IC chips or semiconductor dies are stacked vertically. Similarly, the SIP may include one or more multi-chip modules (MCMs) on which multiple ICs or semiconductor dies are packaged into a unifying substrate. An SIP may also include multiple independent SOCs coupled together via high-speed communication circuitry and packaged in close proximity, such as on a single motherboard, in a single UE, or a single CPU device. The proximity of the SoCs facilitates high-speed communications and the sharing of memory and resources.

The term “orthogonal frequency division multiplexing” (OFDM) may be used herein to refer to a multicarrier modulation technique that transmits data across parallel, mutually orthogonal subcarriers. Wireless communication standards such as Fourth-Generation Long-Term Evolution (LTE), Fifth-Generation New Radio (5G NR), Wireless-Fidelity (IEEE 802.11ax), and Digital Video Broadcasting Terrestrial (DVB-T2) adopt OFDM to achieve spectral efficiency and robustness against multipath fading.

The term “baseband signal-processing chain” may be used herein to refer to a sequence of digital operations that prepare data for transmission or reception in an OFDM transceiver. A typical transmit chain may perform symbol mapping, inverse fast-Fourier transformation, cyclic-prefix insertion, digital predistortion, and digital-to-analog conversion. A typical receive chain may perform analog-to-digital conversion, fast-Fourier transformation, channel estimation, equalization, and symbol demapping.

The term “phase continuity” may be used herein to refer to maintenance of a predictable carrier phase relationship across successive OFDM symbols. Phase continuity may reduce spectral regrowth and may improve demodulation accuracy. Systems may apply a deterministic phase rotation to each symbol according to a predefined phase vector.

The term “phase vector” may be used herein to refer to an ordered set of numerical phase values, each phase value corresponding to an OFDM symbol in a transmission burst. Designers often represent each phase value in floating-point form during algorithm development, yet hardware modules that execute real-time processing may accept fixed-point coefficients.

The term “vector-rotation circuit” may be used herein to refer to a hardware block that receives fixed-point phase coefficients and outputs trigonometric values, such as cosine and sine, within one hardware clock cycle. Coordinate Rotation Digital Computer (CORDIC) architectures may implement such circuits. Some of the embodiments include hardware implementations that incorporate a memory (e.g., a “vector memory,” etc.) that stores fixed-point coefficients in contiguous addresses for rapid access by a vector-rotation circuit.

The term “quantization” may be used herein to refer to a numerical conversion that maps floating-point phase values to fixed-point coefficients according to a bit-precision parameter. A “conversion logic block” may execute operations such as modulus reduction, scaling, rounding, and conditional offset addition to create unsigned coefficients suitable for storage in the vector memory.

Modern 5G and emerging 6G networks deliver wide radio channels, yet many user devices process narrower slices called bandwidth parts (BWP). The gNB center frequency may create a “phase jump” or a constant phase phase progression that appears discontinuous after cyclic-prefix removal when a UE processes a reduced-bandwidth slice. Some embodiments apply digital phase rotation to each OFDM symbol after cyclic-prefix insertion in the transmitter or after cyclic-prefix removal in the receiver to cancel that progression. A processor may pre-compute a lookup table of symbol-specific phase angles from the known frequency offset and symbol schedule, and reconfigurable hardware may multiply each symbol by the matching angle in real time. The same architecture may operate in transmit and receive paths, may adapt to multiple subcarrier spacings, and may integrate within radio units or user devices in Open RAN networks, thereby enabling firmware deployment without added analog circuitry.

Commercial wireless networks (e.g., 5G networks) seek to serve large populations of mobile devices. One way to achieve this is to increase the bandwidth used by the radio network (e.g., the bandwidth available in 5G radios is much larger than the bandwidth available in 4G radios). This may require the mobile devices to be capable of processing the entire wider bandwidth. However, many mobile devices (e.g., legacy handsets, radios embedded in relatively simple IoT devices, etc.) cannot operate in this wideband network (i.e., they cannot process the entire wider bandwidth). BWP segmentation may mitigate this limitation by partitioning the wide channel into smaller segments that bandwidth-constrained UEs may process while full-bandwidth UEs remain unaffected.

During BWP operation the gNB center frequency and the UE slice assignment differ, which may yield a phase progression across successive OFDM symbols. Without digital compensation the progression may degrade demodulation. Phase-rotation components that multiply each symbol by a pre-computed angle may allow for more reliable decoding.

Commercial wireless networks may generate the OFDM baseband signal defined in 3GPP (3d Generation Partnership Project), TECH. SPEC. GRP. RADIO ACCESS NETWORK, NR; Physical Channels and Modulation, 3GPP TS 38.211 § § 5.3-5.4, the entire contents of which are hereby incorporated by reference for all purposes. 3GPP TS 38.211 § 5.3 describes the 5G NR waveform without symbol-wise phase compensation. 3GPP TS 38.211 § 5.4 (“Modulation and Up-Conversion”) then introduces a per-symbol phase-rotation factor and applies it during up-conversion, which places the compensation in the radio domain. Such a radio-domain approach may increase complexity, whereas a digital-domain approach would use fewer resources.

The 5G-NR base-station waveform of 3GPP TS 38.211 § 5.3.1 is denoted

$${s}_{l}^{( p , u )} ( t ) .$$

Up-conversion at the gNB multiplies that waveform by the gNB center frequency f_{gNB}, so the transmitted signal equals

$${s}_{l}^{( p , u )} ( t ) . {e}^{j 2 π {f}_{gNB} t} .$$

After reception the UE down-converts with its carrier frequency (f_{UE}) and obtains a baseband signal expressed as:

$${s}_{l}^{( p , u )} ( t ) . {e}^{j 2 π ( {f}_{gNB} - {f}_{UE} ) t} = {s}_{l}^{( p , u )} ( t ) . {e}^{j {θ}_{l}} \cdot {e}^{j 2 π ( {f}_{gNB} - {f}_{UE} ) ( t - {t}_{CP , l}^{μ} )} ,$$

$$where {θ}_{l} = 2 π ( {f}_{gNB} - {f}_{UE} ) {t}_{CP , l}^{μ} and {t}_{CP , l}^{μ} = {t}_{start , l}^{μ} + {N}_{CP , l}^{μ} {T}_{c}$$

The symbol-start time may be represented by:

$${t}_{start , l}^{μ} = \{ \begin{matrix}0 & l = 0 \\ {t}_{start , l}^{μ} + ( {N}_{u}^{μ} + {N}_{CP , l - 1}^{μ} ) {T}_{c} & otherwise\end{matrix}$$

$$with$$

$${N}_{u}^{μ} = 2048 k \cdot {2}^{- μ}$$

The cyclic-prefix length is:

$${N}_{CP , l}^{μ} = \{ \begin{matrix}512 k \cdot {2}^{- μ} & extended cyclic prefix \\ 144 k \cdot {2}^{- μ} + 16 k & extended cyclic prefix , l = 0 or l = 7 \cdot {2}^{μ} \\ 144 k \cdot {2}^{- μ} & extended cyclic prefix , l \neq 0 or l \neq 7 \cdot {2}^{μ}\end{matrix}$$

These relations define a phase vector θ={θₗ}. Whenever the receiver (e.g., UE) processes a bandwidth-part slice that excludes the gNB digital zero sub-carrier the non-zero f_{gNB} term appears in the base-band signal. Because

$${t}_{start , l}^{μ}$$

increases with l, θₗ also increases. Without digital phase rotation this ramp prevents the UE from decoding the downlink signal.

A straightforward approach to correct this phase discontinuity includes matching rotation factor at the gNB and at the receiver. The gNB multiplies each symbol by

$${e}^{- j 2 π {f}_{gNB} t - {t}_{CP , l}^{μ}} .$$

The receiver may multiply the corresponding signal by

$${e}^{j 2 π {f}_{gNB} t - {t}_{CP , l}^{μ}} .$$

Each phase-vector value depends on the OFDM symbol-start time and the center frequency for the selected numerology μ (subcarrier spacing). This operation applies to downlink and uplink traffic channels (PDSCH and PUSCH) and does not apply to or affect PRACH.

Open-RAN architecture splits a 5G-NR base station into a Distributed Unit (DU) and a Radio Unit (RU). The O-RAN fronthaul interface permits either component to host the phase-rotation function, so an RU-centric or DU-centric placement may be selected without altering higher-layer behavior. That is, network designers may place that function in the RU or in the DU and leave higher-layer behavior unchanged.

Modern 5G radios divide each transmission into short packets called OFDM symbols. If the base station (gNB, etc.) and the phone (UE) reference slightly different carrier frequencies, every new symbol starts at a different angle (e.g., like the hands of two clocks drifting apart). The progression may scramble demodulation unless the equipment realigns the angle at each boundary. Analog-stage realignment solutions add hardware and complicate maintenance. Pre-computed rotated waveforms lack flexibility when sub-carrier spacing changes. A digital-domain technique that updates the rotation value for every symbol avoids extra analog parts, adapts to any numerology, and runs in firmware.

Some embodiments may include a phase-discontinuity-compensation method that keeps a radio device phase-continuous while the device processes a bandwidth-part slice referenced to the gNB center frequency. A processing system may accept a center-frequency parameter f_{gNB} and a sub-carrier-spacing parameter, compute a phase vector by multiplying f_{gNB} by symbol-end-time values, store that vector in memory accessible to a vector-rotation circuit, and instruct the circuit to select a phase value for each OFDM symbol index. A phase-compensation multiplier may rotate each symbol by the selected value and forward a phase-continuous stream to downstream circuitry.

Some embodiments include a phase-vector-calculation method that accepts the center-frequency parameter and an OFDM-numerology parameter, builds a symbol-timing table that maps every symbol index to a symbol-end time, and creates a repeating phase vector by multiplying f_{gNB} by the corresponding end time.

Some embodiments include a phase-vector-calculation method that provides numerical data for phase compensation. The processing system may accept the center-frequency parameter and an OFDM-numerology parameter, build a symbol-timing table that maps each symbol index to a symbol-end time, and create a repeating phase vector by multiplying f_{gNB} by the symbol-end time linked to each index.

Some embodiments may include a phase-vector quantization method that adapts floating-point phase values to a fixed-point format that is compatible with a target hardware circuit. The processing system may map each phase-value into a range (−π, +π) by a modulus operation, scale the mapped value by a resolution factor (e.g., by 2^{(N-3)} in which N denotes a bit-precision value, etc.) equal to the fixed-point step interval, round the scaled value to a nearest integer, add a wrap-offset (e.g., 2^{N}) equal to the span of the fixed-point numeric range when the rounded value falls below zero, and store the adjusted integer in place of the original phase-value to create a quantized phase-vector.

Some embodiments may include a phase pre-compensation circuit that applies the phase-vector during transmission so that a baseband stream leaves the radio device without discontinuities. The circuit may include a processor that stores the phase-vector, a symbol-alignment circuit that forwards each OFDM symbol to a multiplier path, a vector-rotation circuit that supplies cosine and negative-sine components for the selected phase value, a synchronization circuit that delays the symbol until those components are ready, and a phase-compensation multiplier that produces a phase-pre-compensated symbol.

Some embodiments may include a phase compensation circuit that may correct residual phase offsets during reception. The circuit may include a processor that stores the phase vector, a symbol-alignment circuit that forwards each symbol that lacks a cyclic prefix, a vector-rotation circuit that supplies cosine and sine components, a synchronization circuit that delays the symbol until those components are ready, and a multiplier that outputs a phase-compensated symbol suitable for demodulation.

In some embodiments, the radio device may include a processor and a reconfigurable hardware block. The processor may be configured to compute a floating-point phase-vector, convert the phase-vector into a fixed-point format, and store the fixed-point data in read-only memory within the reconfigurable hardware block. The vector-rotation circuit may be configured to read phase values from that memory and produce sine and cosine components. A multiplier may apply the sine and cosine components to streaming complex samples of each OFDM symbol.

Some embodiments may include a symbol-timing table generation method that provides accurate symbol-end time values for subsequent phase-vector computation. The processing system may receive a subcarrier-spacing value, derive a unit-time value equal to the reciprocal of that spacing, obtain a guard-period value, compute a guard-time value, accumulate symbol-start times, calculate a symbol-end-time value for each symbol index, and store the mapping in a table.

Some embodiments may include an adaptive phase-compensation method that supports multiple numerologies without service interruption. The processing system may generate, for each subcarrier-spacing value, a corresponding phase vector, store the vectors in memory, select at run time the vector that matches the active spacing, and apply the selected values to successive symbols.

Some embodiments may include a vector-rotation circuit that computes trigonometric components with minimal latency. The circuit may include an angle register that holds a fixed-point phase value, a coordinate-rotation-digital-computer engine that outputs sine and cosine components within one clock cycle, and an interface that passes the components to a multiplier without interrupting a streaming data path.

In some embodiments, the radio module may integrate the described functions within a transmitter chain. The module may include a physical interface that accepts frequency-domain data, an inverse-fast-Fourier-transform block that converts the data to time-domain samples, a cyclic-prefix-append block that adds a prefix, the phase-pre-compensation circuit that outputs a phase-pre-compensated symbol, and a radio-frequency front end that up-converts the symbol for transmission.

Some embodiments may include a low-latency phase-compensation method that prepares the phase-vector before traffic starts and applies the phase rotation in less than ten percent of one symbol duration. The radio device may compute the vector, load it into hardware, align each symbol with its rotation value, multiply the symbol within a period shorter than the symbol duration, and output a phase-compensated signal with lower latency than analog phase-locked-loop techniques.

Some embodiments include a phase-compensation framework that accepts the gNB center-frequency parameter and a sub-carrier-spacing value, computes a phase vector, and deploys a compensation pipeline that includes symbol alignment, vector rotation, synchronization, and multiplication within a transmit or receive path. The pipeline may rotate each symbol by sine and cosine components derived from the phase vector so that the output stream remains phase-continuous across symbols.

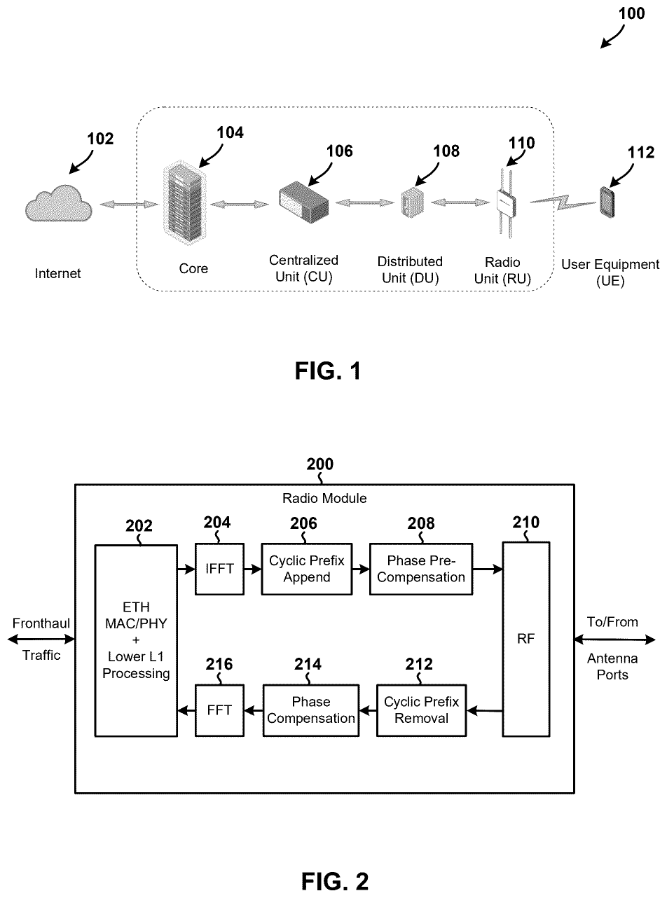

FIG. 1 is an architectural diagram illustrating network components of an example communication system 100 suitable for use with various embodiments. Communication system 100 may operate as a public network (e.g., 5G or 6G) or as a private 5G enterprise network. In the example illustrated in FIG. 1, the communication system 100 includes an Internet gateway 102, a core network 104, a centralized unit 106, a distributed unit 108, a radio unit 110, and user equipment 112.

The Internet gateway 102 may be configured to route external Internet Protocol packets toward core network 104 and accept return packets through secure wired links. The Internet gateway 102 may apply network-address translation and firewall policies and may present public traffic to core network 104 in a format that core network 104 processes without further conversion.

The core network 104 may be configured to authenticate subscribers, manage session contexts, allocate traffic paths, and generate configuration messages that include gNB center-frequency parameter and subcarrier-spacing parameters used for phase-discontinuity compensation. Core network 104 may forward each configuration message to centralized unit 106 through a controlled backhaul interface.

The centralized unit 106 may be configured to execute higher-layer protocol functions, schedule downlink and uplink resources, maintain per-user quality-of-service states, and relay the center-frequency parameter and subcarrier-spacing parameters to distributed unit 108. Centralized unit 106 may prepare time-aligned resource-block assignments that account for phase pre-compensation performed in radio unit 110.

The distributed unit 108 may be configured to process lower-layer protocols, perform hybrid-automatic-repeat-request operations, maintain deterministic timing for fronthaul links, and forward configuration messages and user data to radio unit 110 with bounded delay. Distributed unit 108 may tag each OFDM symbol with a symbol index that radio unit 110 references during phase pre-compensation.

The radio unit 110 may be configured to convert high-speed fronthaul samples into radio-frequency waveforms, apply phase pre-compensation to each outgoing OFDM symbol by selecting a phase value from a resident phase vector, and transmit the phase-adjusted waveform toward user equipment 112. Radio unit 110 may also down-convert received waveforms, apply phase compensation based on a stored phase vector, and forward compensated baseband samples toward distributed unit 108.

User equipment 112 may be configured to receive phase-pre-compensated downlink symbols from radio unit 110, decode those symbols without phase error, generate uplink symbols, and apply internal phase compensation when the network assigns a bandwidth part that excludes the digital zero sub-carrier. User equipment 112 may update its sub-carrier-spacing setting and the associated phase-vector entries supplied by the network.

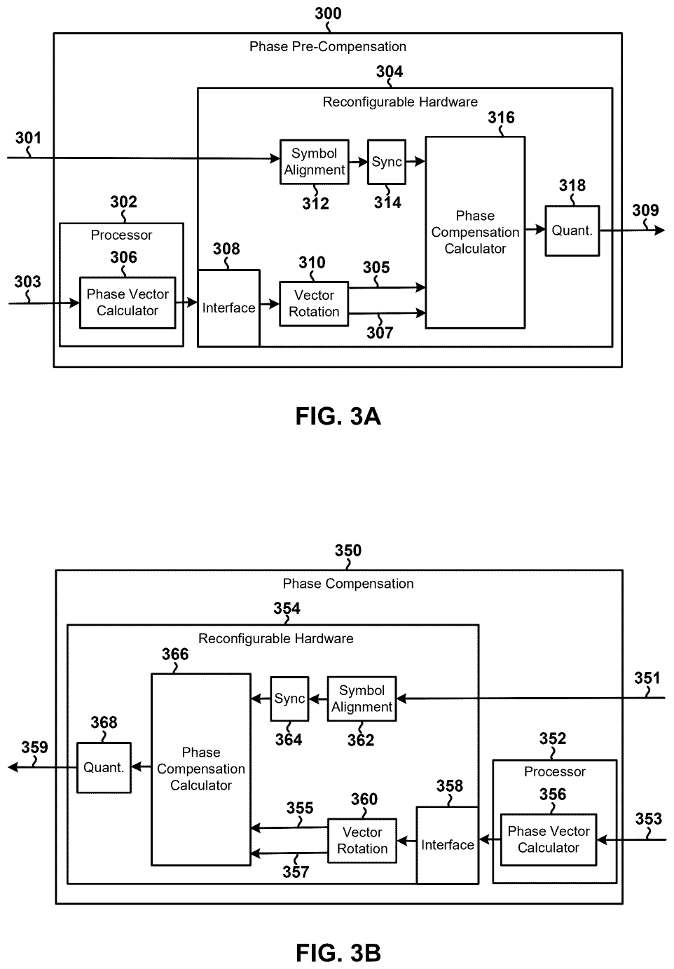

FIG. 2 is a block diagram illustrating internal components of a radio module 200 that could be configured to convert wired fronthaul signals into radio-frequency signals and radio-frequency signals into wired fronthaul signals in accordance with some embodiments. In the example illustrated in FIG. 2, the radio module 200 includes a physical interface 202, an inverse-fast-Fourier-transform (IFFT) component 204, a cyclic prefix append component 206, a phase pre-compensation component 208, a radio-frequency (RF) front-end component 210, a cyclic prefix removal component 212, a phase compensation component 214, and a fast-Fourier-transform (FFT) component 216. The radio module 200 may be part of a radio unit 110, user equipment 112, or an O-RAN-compliant remote radio unit (O-RU). Each component may be configured to provide a specific function or perform a specific task, such as frequency-time conversion, cyclic-prefix processing, or phase compensation that maintains phase continuity between successive symbols referenced to the gNB center frequency.

The physical interface 202 may be configured to terminate wired communications traffic arriving from, or destined for, radio unit 110 or user equipment 112. Physical interface 202 implements an Ethernet MAC/PHY stack and forwards data streams to internal signal-processing components during transmission and receives processed streams during reception.

The IFFT component 204 may convert frequency-domain samples from physical interface 202 into time-domain samples suitable for transmission. Cyclic-prefix-append component 206 may add a cyclic prefix to each set of time-domain samples. Phase-pre-compensation component 208 may rotate the samples after cyclic-prefix insertion by multiplying each OFDM symbol by a phase value selected from a stored phase vector. RF front-end 210 may up-convert the phase-compensated samples to radio-frequency signals and transmit the signals through antenna ports.

For reception, RF front-end 210 may down-convert RF signals received at the antenna ports into time-domain samples. Cyclic-prefix-removal component 212 may discard the cyclic prefix. Phase-compensation component 214 may rotate each symbol with the matching phase value from the same phase vector. FFT component 216 may convert the compensated time-domain samples back to frequency-domain samples. Physical interface 202 may forward those samples as eCPRI option 7-2x traffic toward the DU or core network.

Phase compensation may occur in either the frequency domain or the time domain. In frequency-domain embodiments the rotation precedes the IFFT at the transmitter. In time-domain embodiments the rotation follows cyclic-prefix insertion at the transmitter (TX) and cyclic-prefix removal at the receiver (RX). Time-domain hardware may use a numerically controlled oscillator (NCO) or a CORDIC engine driven by a symbol counter and a phase-lookup table. Time-domain hardware may also use analog phase-locked loops (PLLs) (e.g., for legacy designs, etc.).

In some embodiments, the phase compensation/rotation occurs in the time domain—immediately after cyclic-prefix-append component 206 in the transmit path and after cyclic-prefix-removal component 212 in the receive path—so that transmitted and received OFDM symbols remain phase-continuous even when a bandwidth-part assignment excludes the digital zero sub-carrier of the gNB center frequency.

Thus, FIG. 2 illustrates a radio module 200, which may operate within a radio unit 110 or user equipment 112 device and may also serve as an O-RU in an O-RAN network. Physical interface 202 handles Ethernet (eCPRI, etc.) traffic, components 204 and 216 perform inverse and forward FFTs, components 206 and 212 manage cyclic prefixes, components 208 and 214 supply phase pre-compensation and compensation, and RF front-end 210 performs up- and down-conversion. The phase-rotation function may be placed before the IFFT in the frequency domain or after cyclic-prefix processing in the time domain. For example, in modern O-RAN deployments, the phase-rotation function may be placed after cyclic-prefix processing in the time domain for lower latency and hardware cost.

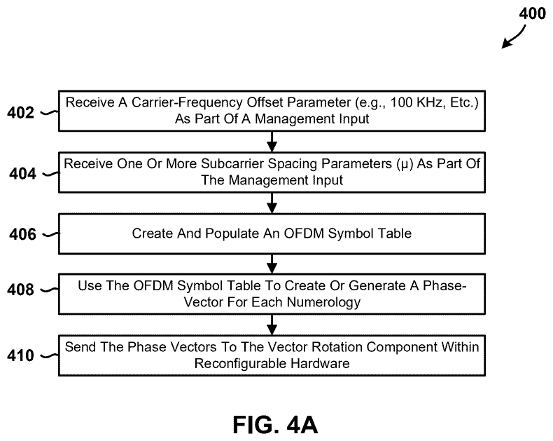

FIGS. 3A and 3B are block diagrams illustrating a phase pre-compensation block 300 (e.g., component 208 described with reference to FIG. 2) and a phase compensation block 350 (e.g., component 214 described with reference to FIG. 2). For the sake of brevity, and because the two blocks share most circuitry, they are described together and any differences are noted. Each component may handle frequency-to-time conversion, cyclic-prefix processing, or phase rotation that keeps successive symbols phase-continuous relative to the gNB center frequency.

In the examples illustrated in FIGS. 3A and 3B, the phase pre-compensation block 300 and phase compensation block 350 each include a processor 302, 352 and reconfigurable hardware 304, 354. The processor 302, 352 may perform floating-point operations or calculations. The reconfigurable hardware block 304, 354 may be implemented in, for example, FPGA or ASIC, and configured to perform fixed-point calculations. The system or processor 302, 352 may include a phase-vector calculator 306, 356 configured to receive management inputs 303, 363. The management inputs 303, 363 may include a gNB center-frequency parameter f_{gNB} and/or a sub-carrier-spacing parameter μ. The phase-vector calculator 306, 356 may generate a phase-vector defined by:

$${θ}_{l} = 2 π {f}_{gNB} {t}_{cp , l}$$

where l is the symbol number and t_{cp,l}=t_{start,l}+N_{cp,l}T_{c}. N_{cp,l} denotes cyclic prefix length and T_{c} denotes the basic time unit. For numerology μ=1, the ηₗ sequence repeats every fourteen symbols (one slot). The processor 302, 352 may send each calculated phase-vector to the reconfigurable hardware block 304, 354 through an interface 308, 358.

The reconfigurable hardware block 304, 354 may be implemented as specialized hardware (e.g., a field-programmable gate array (FPGA) or application-specific integrated circuit (ASIC)). The reconfigurable hardware block 304, 354 may include a symbol alignment component 312, 362, a vector-rotation component 310, 360, a synchronization component 314, 364, a phase compensation calculator 316, 366, and a quantization component 318, 368.

During transmission (FIG. 3A), the symbol-alignment component 312 may accept each OFDM symbol from cyclic-prefix-append component 206. During reception (FIG. 3B), the symbol-alignment component 362 may accept symbols from cyclic-prefix-removal component 212. Both paths may then proceed identically through the remaining components. For example, the vector rotation component 310, 360 may read θₗ and compute cos θₗ and sin θₗ using a coordinate-rotation digital computer (CORDIC) engine. The vector rotation component 310 may generate (cos θₗ, −sin θₗ) as the pre-compensation output. The vector rotation component 360 may generate (cos θₗ, sin θₗ) as the compensation output. The synchronization component 314, 364 may delay the received symbol until the trigonometric pair (i.e., the cosine and sine components) become available from the vector rotation component 310, 360. The phase compensation calculator 316, 366 may multiply the complex symbol by that pair, producing a phase-rotated symbol that is continuous with preceding symbols. The quantization component 318, 368 may quantize or convert the rotated symbol to the fixed-point format required by downstream logic.

For completeness, the periodic term sometimes used in analysis may be written:

$${φ}_{l}^{μ} = 2 π {f}_{gNB} ( {T}_{c} {N}_{CP , l}^{μ} + {t}_{start , l}^{μ} )$$

so that

$${e}^{j {φ}_{l}^{μ}}$$

repeats every fourteen OFDM symbols for numerology μ=1 because

$${N}_{CP , l}^{μ}$$

itself repeats with that period.

The symbol alignment component 312, 362 within reconfigurable hardware 304, 354 may receive an input symbol (e.g., from the cyclic prefix append component 206 with reference to FIG. 2 for transmitting, from the cyclic prefix removal component 212 with reference to FIG. 2 for receiving). The input signal may be an OFDM symbol. The symbol alignment component 312, 362 may send the input symbol to both the vector rotation component 310, 360 and the synchronization component 314, 364.

In some embodiments, vector-rotation component 310, 360 in reconfigurable hardware 304, 354 may read a phase-vector value that corresponds to a current OFDM symbol index and may compute the associated cosine value and the associated sine value. In phase-pre-compensation block 300, the component may output the pair Cos θ and −Sin θ for that value. In phase-compensation block 350, the component may output the pair Cos θ and Sin θ for the same value. In some embodiments, the vector-rotation component may generate each pair by executing a CORDIC algorithm.

In some embodiments, synchronization component 314, 364 in reconfigurable hardware 304, 354 may hold the OFDM symbol in a delay path and may release the symbol when vector-rotation component 310, 360 presents the corresponding cosine and sine values.

In some embodiments, phase-compensation calculator 316, 366 in reconfigurable hardware 304, 354 may multiply the delayed OFDM symbol by the cosine value and by the sine value that synchronization component 314, 364 supplies and may generate a phase-compensated symbol that maintains phase continuity.

In some embodiments, quantization component 318, 368 in reconfigurable hardware 304, 354 may convert each phase-compensated symbol from an internal floating-point or high-precision format to a fixed-point format that downstream circuitry accepts and may output the quantized symbol for further processing. In some embodiments, reconfigurable hardware 304 may include a vector memory that stores the successive unsigned fixed-point coefficients produced by the conversion logic block. Reconfigurable hardware 354 may include an equivalent vector memory for the receive path

Some embodiments may include phase-pre-compensation block 300 and phase-compensation block 350 inside radio module 200. The two blocks may share processor 302, 352 and reconfigurable hardware 304, 354. The processor may accept a gNB center-frequency parameter and a subcarrier-spacing parameter from a management system, may calculate a phase vector with phase-vector calculator 306, 356 according to θ₁=2πf_{gNB}t_{cp,l} and may forward the vector through interface 308, 358 to vector-rotation component 310, 360. The parameter t_{cp,l} denotes the cyclic-prefix end time of symbol index l. For numerology μ=1 the vector repeats after fourteen OFDM symbols.

In the example illustrated in FIG. 3A, the system includes a phase-vector calculator 306, which may be configured to accept the generic phase vector. A first storage element within the calculator may serve as the input buffer, and a second storage element within the same calculator may serve as the precision selector that holds bit-precision value N. The phase-vector calculator 356 illustrated in FIG. 3B may be configured to perform the same input-buffer and precision-selector functions for the receive path.

In some embodiments, the quantization component 318 in FIG. 3A and quantization component 368 in FIG. 3B may each form the conversion logic block. An internal comparator within the conversion logic block may perform the modulus boundary test, and a left-shift arithmetic unit within the same block may be configured to perform the scaling operations.

Reconfigurable hardware 304 in FIG. 3A may include a dedicated memory region that stores the successive unsigned fixed-point coefficients produced by the conversion logic block. This region may be or may include a vector memory for the transmit path. Similarly, the reconfigurable hardware 354 in FIG. 3B may provide an equivalent vector-memory region for the receive path. Each of the phase-compensation multipliers 316 and 366 may be, may implement, or may include a phase-compensation multiplier element. The vector-rotation circuits 310 and 360 may read fixed-point phase coefficients from the respective vector memories and generate cosine and sine values within one hardware clock cycle. Interfaces 308 and 358 act as interface controllers that transfer each hardware-ready phase vector from the vector memory to the corresponding vector-rotation circuit. A formatter inside each conversion logic block may convert each fixed-point coefficient to a hexadecimal string before the coefficient enters the vector memory.

In some embodiments, the vector-rotation circuits may be implemented as a dedicated hardware block that generates cosine and sine components from fixed-point phase values using a CORDIC engine. The CORDIC engine may include an angle register that accepts N-bit fixed-point coefficients from a vector memory, an iterative micro-rotator that performs successive shifts and additions to compute the cosine and sine outputs, and a result register that holds the computed trigonometric pair. The circuit may produce each pair within one hardware clock cycle when configured with pipelined stages, and may be dimensioned to operate over N equal to 8, 12, 16, or 32 bits according to platform requirements. In some embodiments, the CORDIC engine may implement a scale-free variant that omits multiplicative gain correction and store pre-rotation angle values in a hard-coded lookup table indexed by the fixed-point coefficient value.

In various embodiments, the vector-rotation circuit may be embedded within reconfigurable hardware such as a field-programmable gate array (FPGA) or an application-specific integrated circuit (ASIC). The vector-rotation circuit may interface directly with a vector memory that holds the hardware-ready phase vector and use a symbol counter to select a current coefficient. The cosine and sine outputs may feed a fixed-point complex multiplier that processes time-domain OFDM symbols in real time. In some embodiments, the physical layout of the circuit may include combinational logic for sign extension and alignment, clocked registers for synchronization, and shift-add trees that compute the vector rotation through elementary angle decomposition.

Some embodiments may include a method performed by a processing system for phase discontinuity compensation in a wireless communication network. In some embodiments, the method may include receiving, by a processor, a gNB center-frequency parameter f_{gNB} and a subcarrier-spacing parameter, computing, by the processor, a phase-vector that comprises phase-values corresponding to respective OFDM symbol indices, each phase-value calculated as a product of the gNB center-frequency parameter and a corresponding OFDM symbol-end time (e.g., 2πf_{gNB}t_{cp,l}), storing the phase-vector in a memory accessible to a vector-rotation circuit, reading and selecting, by the vector-rotation circuit, one phase-value for each OFDM symbol in a compensation path, and rotating, by a phase-compensation multiplier, a complex representation of the OFDM symbol by the selected phase-value to produce a phase-compensated symbol that maintains phase continuity across successive OFDM symbols. In addition, the vector-rotation circuit may derive the cosine value and the sine value for each phase value through a CORDIC circuit that completes the calculation within one clock cycle. Thus, in some embodiments, rotating the complex representation of the OFDM symbol may include implementing the rotation of each OFDM symbol using a CORDIC circuit configured to calculate corresponding sine and cosine values within a single clock cycle.

In some embodiments, the method may further include the processing system constructing a symbol-timing table that maps each OFDM symbol index to its corresponding symbol-end time derived from the subcarrier-spacing parameter, and using the symbol-timing table to calculate each phase-value in the phase-vector. In some embodiments, the method may further include mapping each calculated floating-point phase-value into a range from minus π to plus π, scaling each mapped phase-value by a factor determined by a fixed-point bit precision minus three (i.e., 2^{(N-3)} for an N-bit fixed-point format), rounding each scaled value to the nearest integer, and storing the rounded integer values as a quantized phase vector (or quantized fixed-point phase-vector suitable for hardware processing). In some embodiments, the method may further include precomputing a plurality of phase-vectors each corresponding to distinct subcarrier-spacing values, storing each precomputed phase-vector in memory, and dynamically selecting at run time one of the stored phase-vectors for use based on an active subcarrier-spacing value. Said another way, the processing system may precompute multiple phase vectors that relate to distinct subcarrier-spacing values, may store the vectors in memory, and may select at run time the phase vector that matches an active subcarrier-spacing value.

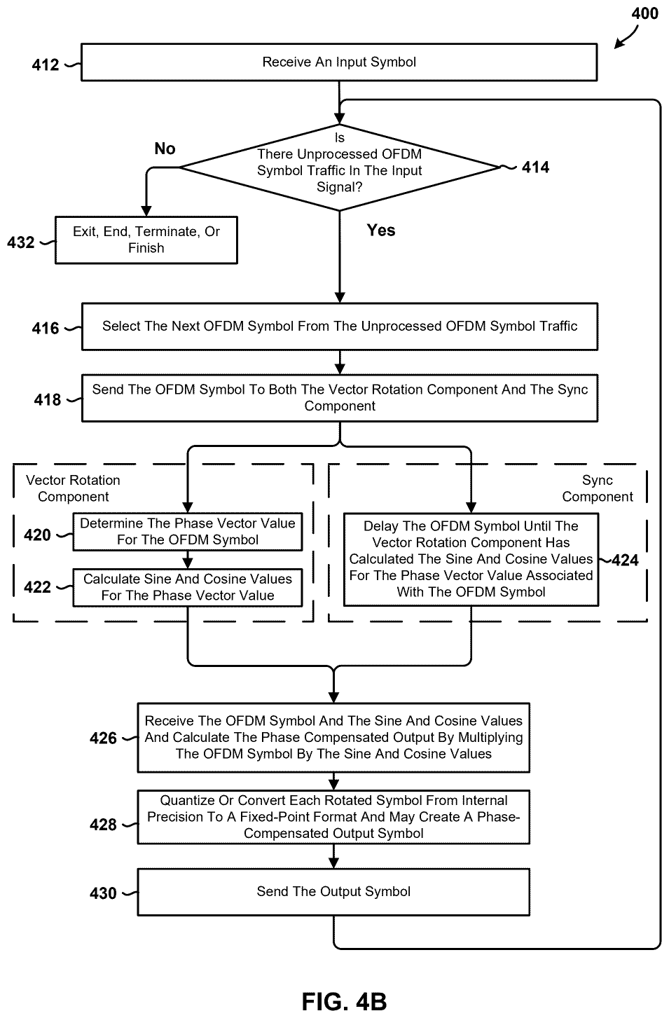

FIGS. 4A and 4B are process flow diagrams illustrating a method 400 of calculating a phase-compensated output signal in accordance with some embodiments. With reference to FIGS. 1-4B, method 400 may be performed in a computing device by a processing system encompassing one or more components or subsystems discussed in this application (e.g., compensation block 300, 350, etc.). For example, a processing system that incorporates phase-pre-compensation block 300 or phase-compensation block 350 may execute method 400. The processing system may include processor 302, 352 and reconfigurable-hardware block 304, 354 described with reference to FIGS. 3A and 3B. For the sake of brevity, and due to overlapping functionality, method 400 is described once for both phase pre-compensation and phase compensation while noting any differences. As such, it should be understood that the following description of method 400 covers both the transmit path and the receive path while noting operational differences between phase-pre-compensation block 300 and phase-compensation block 350.

In an embodiment, blocks 402-410 may be performed during radio initialization (e.g., when the radio is first turned on during a maintenance window). In an embodiment, blocks 412-432 may be performed during radio operation (i.e., on signals that are being transmitted or received). In an alternative embodiment, blocks 402-432 may be performed during radio operation (i.e., on signals that are being transmitted or received).

In block 402, the phase-vector calculator 306, 356 within at least one processor 302, 352 may receive a gNB center-frequency parameter as part of a management input 303, 353. For example, the processor 302, 352 may receive the gNB center-frequency parameter from a network management system. The processor 302, 352 may use the gNB center-frequency parameter to calculate subsequent phase-values.

In block 404, the phase-vector calculator 306, 356 within processor 302, 352 may receive one or more subcarrier spacing parameters (μ) as part of the management input 303, 353. For example, the parameter may equal μ=0 or μ=1 or another numerology value provided by a network-management system. The processor 302, 352 may apply the subcarrier-spacing parameter to derive OFDM symbol timing.

In block 406, the phase-vector calculator 306, 356 within processor 302, 352 may create and populate an OFDM symbol table. The processor may compute a symbol-end-time value for each OFDM symbol index by applying numerology parameters that include cyclic-prefix length, basic time unit T_{c}, and symbol-start time. The processor may store the resulting symbol-end-time values in the OFDM symbol table for later use.

In block 408, the phase-vector calculator 306, 356 within processor 302, 352 may reference or use the OFDM symbol table to create or generate a phase-vector for each numerology. In some embodiments, the processor may calculate each phase value according to θₗ=2πf_{gNB}t_{cp,l} where and t_{cp,l} denotes the cyclic-prefix end time that relates to symbol index l in the timing table. The processor may store the phase vectors in memory for subsequent rotation. These operations are described in greater detail further below.

In block 410, the phase-vector calculator 306, 356 within processor 302, 352 may send the phase-vector data to the vector rotation component 310, 360 within the reconfigurable hardware 304, 354 using interface 308, 358. The processing system may perform this transfer so that the reconfigurable hardware may access and apply the phase-vector data during active communication.

With reference to FIG. 4B, in block 412, the symbol alignment component 312, 362 within reconfigurable hardware 304, 354 may receive an input OFDM symbol. For example, the symbol alignment component 312, 362 within reconfigurable hardware block 304, 354 may receive the symbol from cyclic-prefix-append component 206 in a transmit path or from cyclic-prefix-removal component 212 in a receive path and may prepare the symbol for subsequent phase rotation.

In block 414, the symbol alignment component 312, 362 within reconfigurable hardware 304, 354 may determine whether there is unprocessed OFDM symbol traffic in the input signal (i.e., whether any unprocessed OFDM symbols remain within the received OFDM signal). In response to determining that there is unprocessed OFDM symbol traffic in the input signal (i.e., determination block 414=“Yes”), in block 416 the symbol alignment component 312, 362 within the reconfigurable hardware 304, 354 may select the next unprocessed OFDM symbol from the OFDM symbol traffic or from the input buffer for phase-compensation processing.

In some embodiments, in block 416, the processing system may select the next unprocessed OFDM symbol for processing in response to determining unprocessed symbols exist (i.e., determination block 414=“Yes”). For example, symbol alignment component 312, 362 may select the next OFDM symbol from the input signal buffer to proceed with phase compensation operations.

In block 418, the symbol-alignment component 312, 362 within reconfigurable hardware 304, 354 may send the OFDM symbol to both the vector-rotation component 310, 360 within reconfigurable hardware 304, 354 and the synchronization component 314, 364 within reconfigurable hardware 304, 354. In some embodiments, the component may forward the symbol sequentially or may forward it in parallel. In addition, the vector-rotation component 310, 360 and the synchronization component 314, 364 may receive the symbol at coordinated times so that rotation calculations and synchronization timing remain consistent.

In block 420, the vector rotation component 310, 360 within reconfigurable hardware 304, 354 may determine the phase-vector value for the OFDM symbol. In some embodiments, the vector rotation component 310, 360 may read the phase value that corresponds to the symbol index from a phase vector stored earlier by processor 302, 352.

In block 422, the vector rotation component 310, 360 within reconfigurable hardware 304, 354 may calculate sine and cosine values for the phase-vector value. In the case of phase pre-compensation block 300 (with reference to FIG. 3A), the values may be (cos θ, −sin θ) respectively of the phase-vector value. In the case of phase compensation block 350 (with reference to FIG. 3B), the values may be (cos θ, sin θ) respectively of the phase-vector value.

In some embodiments, the processing system may compute cosine and sine components for the identified phase-value in block 422. For example, the vector rotation component 310/360 may calculate cosine and sine components from the phase-value using a CORDIC algorithm. In phase pre-compensation block 300, the component may output Cos θ and −Sin θ. In phase-compensation block 350 the component may output Cos θ and Sin θ.

In block 424, the synchronization component 314, 364 within reconfigurable hardware 304, 354 may delay the OFDM symbol until the vector rotation component 310, 360 has calculated the sine and cosine values for the phase-vector value associated with the OFDM symbol and presents the matching cosine and sine values. The delay aligns the symbol with its trigonometric components (ensures that symbol and trigonometric components align properly in time).

In some embodiments, operations in blocks 420-422 and block 424 may be performed concurrently or in parallel.

In block 426, the phase compensation calculator 316, 366 within reconfigurable hardware 304, 354 may receive the OFDM symbol and the sine and cosine values at the same time and calculate the phase compensated output by multiplying the OFDM symbol by the sine and cosine values. In some embodiments, in block 426, the phase-compensation calculator 316, 366 may multiply the delayed OFDM symbol by the cosine value and by the sine value and may generate a rotated symbol that realigns the phase progression imposed by the gNB center frequency.

In block 428, the quantization component 318, 368 within reconfigurable hardware 304, 354 may convert each rotated symbol from internal precision to a fixed-point format and may create a phase-compensated output symbol. For example, quantization component 318/368 within reconfigurable hardware 304/354 may convert the rotated OFDM symbol from floating-point format into a fixed-point numeric format (e.g., to provide an output symbol compatible with subsequent signal-processing hardware, etc.).

In block 430, the reconfigurable hardware 304, 354 may send the output signal (e.g., to the RF component 210 with reference to FIG. 2 for transmission, to FFT component 216 with reference to FIG. 2 for receiving). In some embodiments, in block 430, the processing system may forward the phase-compensated output symbol toward radio-frequency component 210 for transmission or toward FFT component 216 for reception.

In response to determining that there is no unprocessed OFDM symbol traffic in the input signal (i.e., determination block 414=“No”), then in block 432 the process may exit, end, terminate, or finish.

In an embodiment, the implementation of method 400 may be split between the processor 302, 352 and the reconfigurable hardware 304, 354. This may allow all of the floating-point calculations to be performed in the processor 302, 352, which may result in lower complexity while still having the highest possible accuracy. This also allows the reconfigurable hardware 304, 354 to only use the vector rotation component 310, 360 to calculate sine and cosine values, which may result in reducing the latency and the necessary hardware resources.

As discussed, method 400 may divide the processing operations between processor 302, 352 and reconfigurable hardware block 304, 354. Processor 302, 352 may perform floating-point calculations (e.g., computing symbol timings and phase-vectors, etc.) to reduce hardware complexity and improve accuracy. The reconfigurable hardware block 304, 354 may rapidly perform fixed-point calculations (e.g., vector rotation and multiplication, etc.) to reduce latency and required hardware resources. As a result, method 400 may achieve a latency below 10% of one OFDM symbol duration, which is roughly an order-of-magnitude lower than other solutions.

In alternative embodiments, blocks 402-432 may be performed entirely using a processor, entirely using reconfigurable hardware, or using any combination of one or more processors and reconfigurable hardware.

Some embodiments may include a phase-discontinuity compensation circuit within the radio module 200 that forms part of either the radio unit 110 or the user-equipment 112. The circuit may correspond to phase-pre-compensation block 300 in a transmit path and to phase-compensation block 350 in a receive path, as illustrated and described with reference to FIGS. 3A and 3B. Each block may sit between the cyclic-prefix operation and the radio-frequency stage in the radio unit 110 or between the radio-frequency stage and the fast-Fourier-transform stage in the user-equipment 112.

In some embodiments, the circuit may include a processor configured to receive a gNB center-frequency parameter and a subcarrier-spacing parameter, build a symbol-timing table that maps each (OFDM) symbol index to a cyclic-prefix end-time, compute a phase-vector whose entries equal 2πf_{gNB}t_{cp,l} or in which each phase-value equals a product of the gNB center-frequency parameter and the cyclic-prefix end-time mapped to the corresponding OFDM symbol index, and write the phase-vector into a memory. The memory may be coupled to the processor and store the phase-vector. In some embodiments, the circuit may include a reconfigurable hardware block coupled to the memory. The reconfigurable hardware block may include a symbol-alignment unit that detects OFDM symbol boundaries in a complex sample stream and forwards each detected OFDM symbol along parallel paths, a vector-rotation unit that reads a phase value for each symbol and produces a cosine component and a sine component, a synchronization unit that delays the symbol until both components become available, a phase-compensation multiplier that multiplies the symbol by the components, and a quantization unit that converts the rotated symbol into a fixed-point format suitable for radio-frequency processing. Some embodiments may include an output interface that forwards each fixed-point rotated symbol toward a radio-frequency front end for transmission or toward a fast-Fourier-transform stage for reception.

In some embodiments, the processor may be further configured to map each phase-value into a numeric range from minus π to plus π (−π, +π), scale each mapped phase-value 2^{(N-3)} where N denotes bit precision, round each scaled phase-value to a nearest integer, and store each rounded integer in the memory as a fixed-point phase-vector that the vector-rotation unit reads. The vector-rotation unit may implement a CORDIC engine that generates the cosine component and the sine component within one hardware clock cycle. The processor may compute multiple phase vectors that correspond to distinct subcarrier-spacing parameters, store the vectors in the memory, and instruct the vector-rotation unit to select one vector according to an active subcarrier-spacing parameter. The vector-rotation unit may output cos θ and −sin θ in a transmit path and cos θ and sin θ in a receive path. The processor may perform floating-point arithmetic and the reconfigurable-hardware block may perform fixed-point arithmetic to reduce latency. The symbol-alignment unit, synchronization unit, vector-rotation unit, phase-compensation multiplier, and quantization unit may reside on a single field-programmable-gate-array die inside radio module 200. The output interface may insert each fixed-point rotated symbol into an Ethernet-based fronthaul stream in radio unit 110 or into an internal baseband-processing bus in user equipment 112.

Some embodiments may include computer-implemented methods performed by a processing system included in a radio device and includes at least one processor and a memory. In some embodiments, the method may include receiving, by the processor, a plurality of subcarrier-spacing parameters, each subcarrier-spacing parameter defining a frequency interval between adjacent subcarriers of an OFDM numerology. In some embodiments, the method may include, for each received subcarrier-spacing parameter, determining a guard-period value equal to the cyclic-prefix length expressed in OFDM symbol units, calculating a unit-time value equal to the reciprocal of the subcarrier-spacing parameter, computing a guard-time value equal to the product of the guard-period value and the unit-time value, identifying a plurality of OFDM symbol indices associated with the subcarrier-spacing parameter, and, for each OFDM symbol index of the plurality, deriving a start-time value equal to an accumulated duration that precedes the OFDM symbol index, the accumulated duration including integer multiples of the unit-time value and the guard-time value, deriving an end-time value equal to the sum of the start-time value and the guard-time value, and writing, to a symbol-timing table stored in the memory, a table entry that includes the OFDM symbol index and the corresponding end-time value. In some embodiments, the method may include storing, in the memory, the symbol-timing table for subsequent phase-vector generation. In some embodiments, the method may include outputting the stored symbol-timing table toward circuitry that computes phase vectors for phase-discontinuity compensation.

In some embodiments, deriving the start-time value equal to the accumulated duration that precedes the OFDM symbol index may include summing n occurrences of the unit-time value and n occurrences of the guard-time value, where n equals the ordinal position of the OFDM symbol index within the plurality. In some embodiments, the plurality of OFDM symbol indices for a subcarrier-spacing parameter corresponding to numerology μ=0 may include fourteen sequential indices. In some embodiments, the method may further include updating, by the processor, the guard-period value responsive to a configuration change that alters the cyclic-prefix length and rewriting updated end-time values into the symbol-timing table without interrupting symbol processing. In some embodiments, the processing system may include programmable logic configured to execute fixed-point arithmetic when computing the unit-time value and the guard-time value. In some embodiments, the symbol-timing table stored in the memory may form a cyclic data structure that repeats with a period equal to a time slot of the corresponding numerology. In some embodiments, the method may further include transmitting the symbol-timing table from the memory to reconfigurable hardware that multiplies successive OFDM symbols by phase-rotation values derived from the symbol-timing table. In some embodiments, the radio device may operate as a transmitter and outputting the stored symbol-timing table may include sending the table to hardware that performs phase pre-compensation after a cyclic-prefix-append operation. In some embodiments, the radio device may operate as a receiver and outputting the stored symbol-timing table may include sending the table to hardware that performs phase compensation after a cyclic-prefix-removal operation. In some embodiments, receiving the plurality of subcarrier-spacing parameters may include parsing a configuration message that conforms to a 3GPP new-radio physical-layer interface.

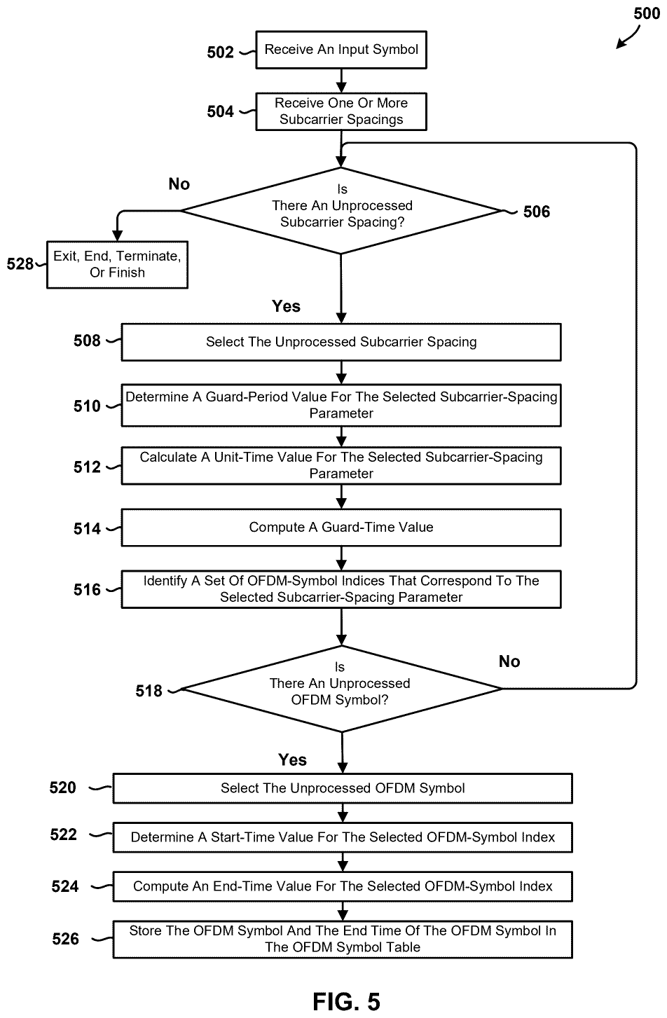

FIG. 5 is a process flow diagram illustrating a method 500 of creating and populating an OFDM symbol table in accordance with some embodiments. Method 500 may be performed by processor 302 or processor 352 (e.g., as part of block 406 with reference to FIG. 4).

In block 502, the processing system may receive one or more subcarrier-spacing parameters (e.g., the subcarrier-spacing parameters received as part of block 404 with reference to FIG. 4). For example, the processor may parse a management message that lists subcarrier-spacing parameters for numerology μ=0 and numerology μ=1, where each parameter defines the frequency interval between adjacent subcarriers.

In block 504, the processing system may create an empty OFDM symbol table. For example, the processor may allocate a two-column data structure that reserves a first column for an OFDM symbol index and a second column for an OFDM symbol end-time value.

In block 506, the processing system may determine whether there is an unprocessed subcarrier spacing. For example, the processor may compare a loop counter with the quantity of subcarrier-spacing parameters received in block 502.

In response to determining that there is an unprocessed subcarrier spacing (i.e., determination block 506=“Yes”), in block 508 the processing system may select an unprocessed subcarrier-spacing parameters. For example, the processor may read the subcarrier-spacing parameter that corresponds to numerology μ=0 and mark that parameter as processed.

In block 510, the processing system may determine a guard-period value for the selected subcarrier-spacing parameter. The guard-period value expresses the channel delay spread in OFDM symbol units. For example, the processor may reference a channel-profile table and retrieve a guard-period value equal to sixteen samples.

In block 512, the processing system may calculate a unit-time value for the selected subcarrier-spacing parameter. The unit-time value equals the reciprocal of the subcarrier-spacing parameter expressed in seconds. For example, a fifteen-kilohertz spacing corresponds to a unit-time value of 66.67 μs.

In block 514, the processing system may compute a guard-time value. For example, the processor may multiply the guard-period value by the unit-time value and store the product as the guard-time value.

In block 516, the processing system may identify a set of OFDM symbol indices that correspond to the selected subcarrier-spacing parameter. For example, numerology μ=0 includes fourteen OFDM symbol indices in one time slot.

In block 518, the processing system may evaluate whether an unprocessed OFDM symbol index remains within the set identified in block 516.

In response to determining that there is an unprocessed OFDM symbol (i.e., determination block 518=“Yes”), in block 520 the processing system may select the unprocessed OFDM symbol. Said another way, the processing system may select an unprocessed OFDM symbol index when the evaluation in block 518 returns affirmative. For example, the processor may select OFDM symbol index three from the set associated with numerology μ=0.

In block 522, the processing system may determine a start-time value for the selected OFDM symbol index. The start-time value may equal an accumulated duration of unit-time values and guard-time values that precede the selected OFDM symbol index. For example, the processor may sum three unit-time intervals and three guard-time intervals to obtain the start-time value for OFDM symbol index three.

In block 524, the processing system may compute an end-time value for the selected OFDM symbol index. The end-time value may equal the sum of the start-time value and the guard-time value. For example, the processor may add the guard-time value to the start-time value and store the result as the end-time value.

In block 526, the processing system may write a row into the OFDM symbol table that includes the selected OFDM symbol index (e.g., in the first column, etc.) and the corresponding end-time value (e.g., in the second column, etc.). For example, the processor may write OFDM symbol index “3” and an end-time value of 600 μs into the table.

In response to determining that there is not an unprocessed OFDM symbol (i.e., determination block 518=“No”), in block 506 the processing system may repeat the evaluation for additional unprocessed subcarrier-spacing parameters after the set of OFDM symbol indices for the current parameter has been processed.

In response to determining that there is not an unprocessed subcarrier spacing (i.e., determination block 506=“No”), then in block 528 the process may exit, end, terminate, or finish. In some embodiments, in block 528, the processing system may cease operations after the evaluations in block 518 and block 506 return negative for unprocessed entries. The OFDM symbol table created through blocks 502-528 may now include each OFDM symbol index and each corresponding end-time value for every subcarrier-spacing parameter received in block 502.

Some embodiments may include symbol-timing generator that includes a processor and a memory. In some embodiments, the symbol-timing generator may be included in the either the radio unit 110 or the user equipment 112 and may operate with the phase-pre-compensation block 300 and the phase-compensation block 350 illustrated in FIGS. 3A and 3B. The generator may provide a symbol-timing table to the phase-vector calculator 306 or 356 and may therefore support phase-discontinuity compensation in a transmit path or a receive path.

In some embodiments, the processor may receive a plurality of subcarrier-spacing parameters, each parameter defining a frequency interval between adjacent subcarriers of an OFDM numerology, may obtain for each parameter a guard-period value that represents a channel delay spread expressed in basic-time-unit samples, may calculate a unit-time value equal to a reciprocal of the subcarrier-spacing parameter, may compute a guard-time value equal to a product of the guard-period value and the unit-time value, may identify a plurality of symbol indices associated with the subcarrier-spacing parameter, may derive for each symbol index a start-time value equal to an accumulated duration that precedes the symbol index and includes integer multiples of the unit-time value and the guard-time value, may derive for each symbol index an end-time value equal to a sum of the start-time value and the guard-time value, and may write a table entry that contains the symbol index and the corresponding end-time value into the memory. In some embodiments, the memory may store the table entries as a symbol-timing table that downstream logic reads during phase-vector generation.

In some embodiments, the processor may parse a configuration message that carries each subcarrier-spacing parameter, may reference a channel-profile table to obtain a corresponding guard-period value, and may perform floating-point arithmetic while calculating the unit-time and guard-time values. A symbol-timing table linked to a numerology may repeat with a period equal to one time slot of that numerology. The processor may update the guard-period value when a measured channel delay spread changes and may overwrite revised end-time values in the symbol-timing table without halting symbol-index processing. Reconfigurable logic may read the symbol-timing table and may multiply successive symbols by phase-rotation values derived from the table.

In some embodiments, the symbol-timing generator may allocate a two-column data structure in the memory, may reserve a first column for a symbol index, and may reserve a second column for an end-time value. The processor may process each received subcarrier-spacing parameter sequentially, may obtain an associated guard-period value from a channel-profile table, may calculate a reciprocal-based unit-time value, may compute a guard-time value as a product of the guard-period value and the unit-time value, may identify a sequence of symbol indices for the numerology, and may derive start-time and end-time values for each symbol index before writing each pair to the symbol-timing table. The processor may repeat the obtain, calculate, compute, identify, derive, and write operations until the symbol-timing table maps every processed symbol index to a corresponding end-time value, and a downstream phase-vector calculator may access that table to derive phase-rotation coefficients that compensate phase discontinuity in either a transmission path or a reception path.

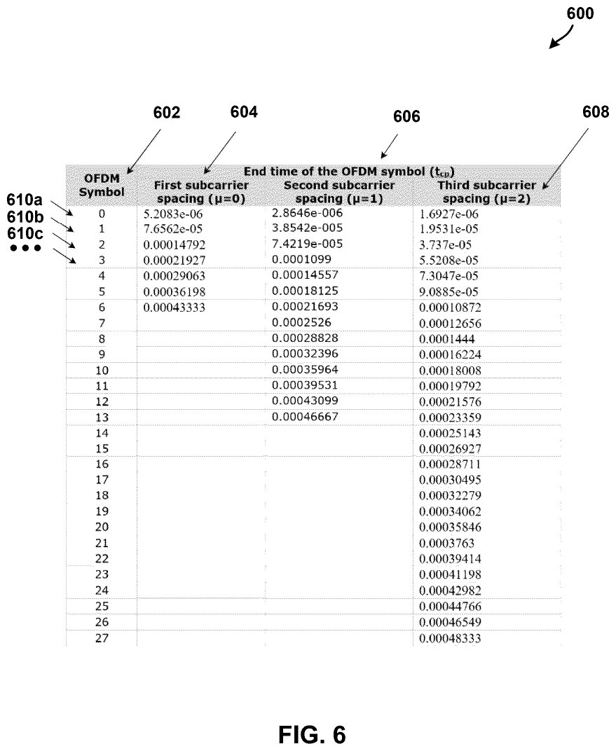

FIG. 6 is a block diagram that illustrates a table 600 including OFDM symbols and the corresponding end times of the OFDM symbols according to an example embodiment. Table 600 may have been created and populated as described in method 500 (with reference to FIG. 5).

Table 600 includes end times of OFDM symbols for three subcarrier-spacing parameters. Column 602 includes the OFDM symbols, and each OFDM symbol is represented in a single row (e.g., 610a, 610b, 610c, . . . ). Column 604 includes the end times of the OFDM symbols for the first subcarrier spacing, column 606 includes the end times of the OFDM symbols for the second subcarrier spacing, and column 608 includes the end times of the OFDM symbols for the third subcarrier spacing. Thus, the end time of the second OFDM symbol in the second subcarrier spacing is 3.8542×10⁻⁵. (i.e., the value in row 610b and column 606). The end times of the OFDM symbols for each subcarrier spacing repeat with different periods (e.g., the end times of the OFDM symbols for the first subcarrier spacing repeat for 7 OFDM symbols, the end times of the OFDM symbols for the second subcarrier spacing repeat for 14 OFDM symbols, and the end times of the OFDM symbols for the third subcarrier spacing repeat for 28 OFDM symbols).

Some embodiments may include computer-implemented method executed by a processing system that includes a processor and a memory within a radio device. In some embodiments, the method may include receiving, by the processor, a gNB center-frequency parameter that specifies the transmitter center frequency and receives a plurality of sub-carrier-spacing parameters that each define the interval between adjacent sub-carriers of an OFDM numerology. For each sub-carrier-spacing parameter the processor selects a symbol-timing table in memory, the processing system calculates a generic phase vector whose entries equal 2πf_{gNB}t_{cp,l}, and converts the generic phase-vector into an updated phase-vector that conforms to a fixed-point numeric format of a target hardware platform by mapping each phase value into a numeric interval that spans greater than or equal to −π and less than or equal to +π through a modulus operation, multiplying each mapped phase value by 2^{(N-3)} (in which N denotes a bit-precision value), rounding each multiplied phase value to a nearest integer, and adding 2^{N} to any rounded integer that is negative. The method may further include storing, by the processor, the updated phase-vector in the memory at an address that a vector-rotation circuit accesses during phase-discontinuity compensation. For example, in an embodiment, the bit-precision value N may equal 16, multiplying each mapped phase value may include multiplying each mapped phase value by 2^{(N-3)}=2⁽¹⁶⁻³⁾=2¹³, and storing the updated phase-vector in the memory may include writing 16-bit unsigned integers into the memory.

In some embodiments, the processor may derive each symbol-end-time value in the symbol-timing table as a sum of a symbol-start-time value and a guard-time value, and the guard-time value may equal a product of a guard-period value and a unit-time value that corresponds to the subcarrier-spacing parameter. In addition, the plurality of phase values in the generic phase-vector may repeat with a period of fourteen symbol indices for numerologies μ=0 and μ=1, and with a period equal to 14·2^{-μ} symbol indices for numerology values greater than one (e.g., 14 symbols for μ=0; 7 for μ=1; etc.). In some embodiments, the processor may transmit the updated phase-vector from the memory to a reconfigurable-hardware interface that supplies the updated phase-vector to the vector-rotation circuit without intervention by software during active communication.

In some embodiments, the method may further include repeating the operations of selecting the symbol-timing table, calculating the generic phase-vector, converting the generic phase-vector into an updated phase-vector that conforms to a fixed-point numeric format of a target hardware platform, and storing the updated phase-vector in the memory until the processor determines that no unprocessed subcarrier-spacing parameter of the plurality remains. In some embodiments, mapping each phase value into the numeric interval may include applying a modulus operation that yields a remainder in the interval (−π, +π). In some embodiments, the updated phase-vector stored in the memory may provide fixed-point phase-rotation coefficients that reconfigurable hardware multiplies with complex baseband samples to maintain phase continuity between successive OFDM symbols. In some embodiments, the processor may receive the gNB center-frequency parameter and/or the plurality of subcarrier-spacing parameter during a system-initialization interval. In some embodiments, the processor may use floating-point arithmetic to calculate the generic phase-vector and/or convert the generic phase-vector into an updated phase-vector that conforms to a fixed-point numeric format of a target hardware platform.

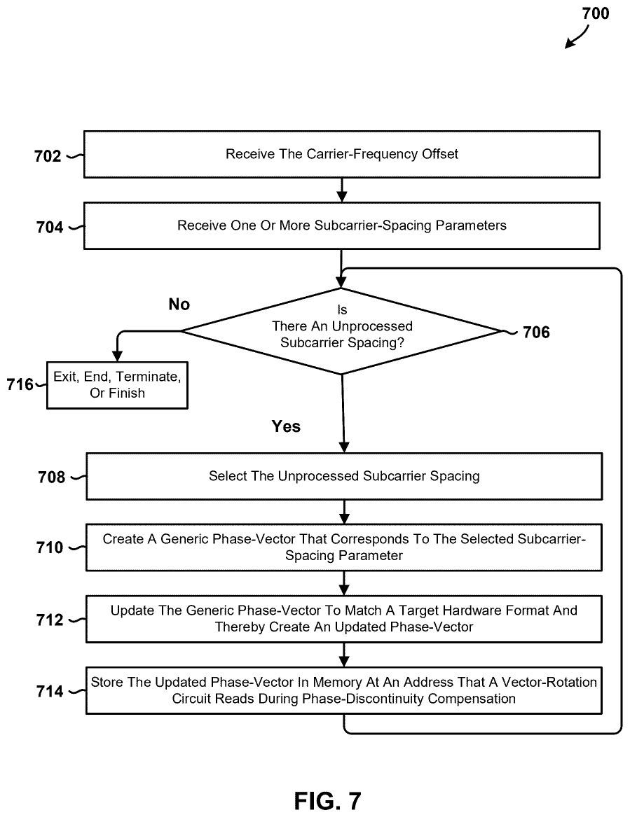

FIG. 7 is a process flow diagram illustrating a method 700 of creating phase-vectors in accordance with some embodiments. Method 700 may be performed by a processor 302, 352 (e.g., as part of block 408 with reference to FIG. 4).

In block 702, the processing system may receive the gNB center-frequency parameter (e.g., the parameter received as part of block 402 with reference to FIG. 4). For example, the processor may parse a configuration message delivered during call setup and extract a value that equals 3.6 gigahertz.

In block 704, the processing system may receive one or more subcarrier-spacing parameters (e.g., the subcarrier-spacing parameters received as part of block 404 with reference to FIG. 4). For example, the processor may extract a fifteen-kilohertz parameter that represents numerology μ=0 and a thirty-kilohertz parameter that represents numerology μ=1.

In block 706, the processing system may determine whether an unprocessed subcarrier-spacing parameter remains in the plurality received in block 704. For example, the processor may compare the loop counter with a quantity that equals two when the configuration message includes two parameters (e.g., the fifteen-kilohertz and thirty-kilohertz parameters, etc.).

In response to determining that there is an unprocessed subcarrier spacing (i.e., determination block 706=“Yes”), in block 708 the processing system may select the unprocessed subcarrier spacing. For example, the processor may select the fifteen-kilohertz parameter during a first iteration and mark that parameter as processed so that the loop counter advances.

In block 710, the processing system may create a generic phase-vector that corresponds to the selected subcarrier-spacing parameter. For example, the processor may read a symbol-timing table stored in memory, multiply the gNB center-frequency parameter by each symbol-end-time value listed in the table, and assemble the products into an ordered list associated with symbol indices (i.e., indexed by symbol number).

In block 712, the processing system may update the generic phase-vector to match a target hardware format and thereby create an updated phase-vector. For example, the processor may apply a modulus-2π operation to each phase value to constrain the value within the interval (−π, +π), multiply the constrained value by 2^{(N-3)} when a fixed-point width of N bits applies, round the result to the nearest integer, and add 2^{N} when the rounded integer holds a negative sign.

In block 714, the processing system may store the updated phase-vector in memory at an address that a vector-rotation circuit reads during phase-discontinuity compensation. For example, the processor may write sixteen-bit unsigned integers that represent the updated phase-vector and may transmit the same data through interface 308 or interface 358 when the vector-rotation circuit resides outside the processor address domain.

In response to determining that there is not an unprocessed subcarrier spacing (i.e., determination block 706=“No”), in block 716 the process may exit, end, terminate, or finish.

Some embodiments may include a phase-vector generator circuit located in a radio module that resides in a radio unit 110 or in user equipment 112. The circuit may include a processor configured to receive a gNB center-frequency parameter, receive a plurality of subcarrier-spacing parameters, and select, for each subcarrier-spacing parameter, a symbol-timing table stored in a memory that maps each symbol index of the numerology to a symbol-end-time value. The processor may calculate, for each symbol-end-time value, a phase value that equals 2πf_{gNB}t_{end}, may assemble the phase values into a generic phase vector, may map each phase value into an interval greater than −π and less than or equal to +π, may multiply each mapped value by a scale factor 2^{(N-F)} where N denotes a bit-precision value and F denotes the count of integer bits in the fixed-point representation, may round the result to a nearest integer, may add 2^{N} to integers that are negative, and may thus create an updated phase vector that conforms to a numeric format required by target hardware. The processor may store the updated phase vector in the memory, and the circuit may include an interface that supplies the updated phase vector from the memory to a vector-rotation circuit that generates phase-rotation coefficients for phase-discontinuity compensation.

In some embodiments, the processor may derive each symbol-end-time value as a sum of a symbol-start-time value and a guard-time value, and the guard-time value may equal a product of a guard-period value and a unit-time value that corresponds to the related subcarrier-spacing parameter. The interface may transfer the updated phase vector to reconfigurable logic without processor interaction during active data transmission. The phase values in the generic phase vector may repeat with a period equal to 14/2^{μ} symbol indices for a numerology identified by index u when the normal cyclic-prefix configuration applies. The processor may perform the calculating, mapping, multiplying, rounding, and storing operations for each subcarrier-spacing parameter until no unprocessed parameter remains. The processor may execute the mapping operation through a modulus calculation that constrains each phase value to the interval greater than −π and less than or equal to +π. The interface may deliver the updated phase vector to hardware that multiplies complex base-band samples by rotation coefficients derived from the vector and thus maintains phase continuity between successive OFDM symbols. The processor may execute the calculating and mapping operations with floating-point arithmetic and may write the updated phase vector to the memory during an initialization interval that precedes wireless transmission or reception.

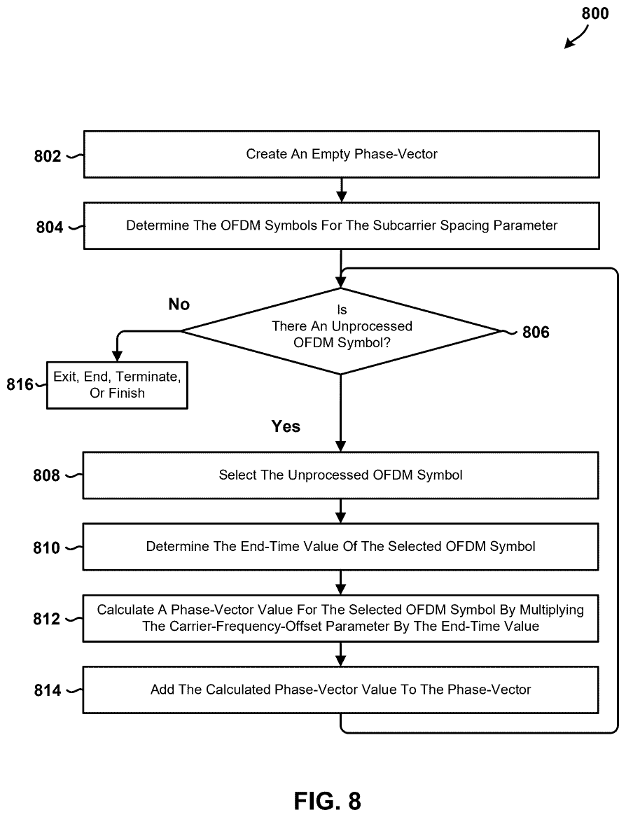

FIG. 8 is a process flow diagram illustrating a method 800 of creating a generic phase-vector in accordance with some embodiments. Method 800 may be performed by a processor 302, 352 (e.g., as part of block 710 with reference to FIG. 7). OFDM divides the channel into many narrow sub-carriers separated by a fixed interval called the sub-carrier-spacing parameter, and a phase vector assigns a per-symbol rotation that cancels the phase progression introduced by the gNB center frequency.

In block 802, the processing system may create an empty phase-vector. For example, the processor may allocate contiguous memory that stores fixed-length words and may clear each word so that later operations insert phase values at known offsets.

In block 804, the processing system may determine the OFDM symbols for the subcarrier spacing parameter. For example, the processor may read a numerology description that lists fourteen symbol indices for one time slot and may copy those indices into a working register set.

In block 806, the processing system may determine whether any unprocessed OFDM symbol remains. For example, the processor may compare a loop counter with a symbol-count variable that tracks the quantity of indices loaded in block 804.

In response to determining that there is an unprocessed OFDM symbol (i.e., determination block 806=“Yes”), in block 808 the processing system may select the unprocessed OFDM symbol. For example, the processor may pop the next index from a first-in-first-out queue and may mark that index as processed.

In block 810, the processing system may determine the end-time value of the selected OFDM symbol. For example, the processor may use the subcarrier-spacing parameter and the symbol index to fetch a symbol-end-time value from the symbol-timing table 600. In addition, the processor may compute the end-time value directly from numerology parameters when the table is absent.

In block 812, the processing system may calculate a phase-vector value for the selected OFDM symbol by multiplying the gNB center-frequency parameter by the end-time value. For example, the processor may execute a floating-point multiply instruction that returns the product 2πf_{gNB}t_{end}.

In block 814, the processing system may add the calculated phase-vector value to the phase-vector. For example, the processor may write the product into the memory location that corresponds to the selected symbol index.

In response to determining that there is not an unprocessed OFDM symbol (i.e., determination block 806=“No”) and the loop counter confirms that no unprocessed OFDM symbol remains, in block 816 the process may exit, end, terminate, or finish.

Some embodiments may include a computer-implemented method performed by a processing system that includes at least one processor and a memory in a radio device. In some embodiments, the method may include receiving by the processor a gNB center-frequency parameter that identifies the transmitter center frequency. In some embodiments, the method may include receiving by the processor a plurality of subcarrier-spacing parameters. Each subcarrier-spacing parameter may define a frequency interval between adjacent subcarriers of an OFDM numerology. In some embodiments, the method may include, for each subcarrier-spacing parameter of the plurality, selecting by the processor a symbol-timing table stored in the memory that maps each symbol index of the numerology to a symbol-end-time value, calculating by the processor a generic phase vector that comprises a plurality of phase values that are each equal to 2·π·(gNB center-frequency parameter) (symbol-end-time value) and associated with the symbol index listed in the symbol-timing table, converting by the processor the generic phase vector into an updated phase vector that conforms to a fixed-point numeric format of a target hardware platform by, for each phase value, mapping the phase value into an interval greater than −π and less than or equal to +π through a modulus-2π operation, multiplying the mapped phase value by 2^{(N-3)} where N denotes a selectable bit precision, rounding the multiplied phase value to a nearest integer, and adding 2^{N} to the rounded integer whenever the rounded integer has a negative value. In some embodiments, the method may include storing the updated phase vector in the memory at an address that a downstream vector-rotation circuit accesses during phase-discontinuity compensation.

In some embodiments, the processor may derive each symbol-end-time value as a sum of a symbol-start-time value and a guard-time value, and the guard-time value equals a product of a guard-period value and a unit-time value that corresponds to the related subcarrier-spacing parameter. In some embodiments, the processor may parse a configuration message that conforms to a 3GPP NR physical-layer interface to obtain the gNB center-frequency parameter and the plurality of subcarrier-spacing parameters. In some embodiments, the plurality of phase values in the generic phase vector may repeat with a period of 14/2^{μ} symbol indices when the related subcarrier-spacing parameter corresponds to numerology μ. In some embodiments, the method may include may transmitting, by an interface coupled to the memory, the updated phase vector to reconfigurable logic that multiplies complex base-band samples by rotation coefficients derived from the updated phase vector and maintains phase continuity between successive OFDM symbols.

In some embodiments, the processor may execute floating-point arithmetic to compute the generic phase vector and fixed-point arithmetic to convert the generic phase vector into the updated phase vector. In some embodiments, the processor may perform the receiving, selecting, calculating, converting, and storing operations during a system-initialization interval that precedes wireless transmission or reception. In some embodiments, the processor may update the guard-period value responsive to a measured change in channel delay spread and overwrite revised end-time values in the symbol-timing table without halting symbol-index processing. In some embodiments, the memory may forward the updated phase vector to hardware that performs phase pre-compensation after cyclic-prefix insertion when the radio device operates as a transmitter and to hardware that performs phase compensation after cyclic-prefix removal when the radio device operates as a receiver. In some embodiments, the bit-precision value P may be selectable from a set that includes at least an eight-bit precision and a sixteen-bit precision. In some embodiments, the processor may select the bit-precision value according to a capability of the target hardware platform.

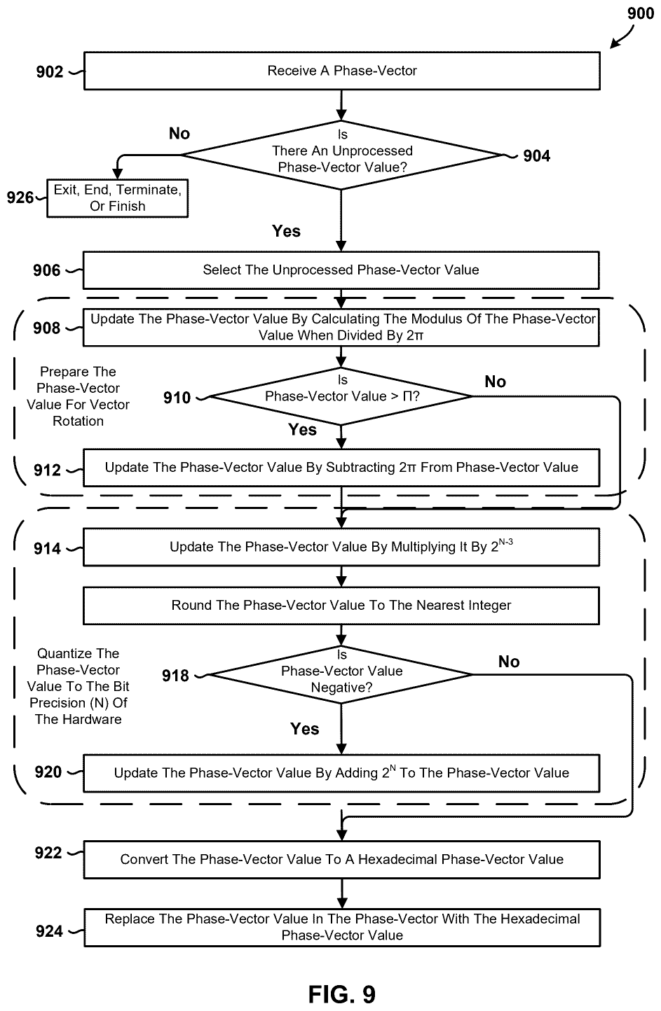

FIG. 9 is a process flow diagram illustrating a method 900 of updating a generic phase-vector for a specific hardware platform in accordance with some embodiments. Method 900 may be performed by a processor 302, 352 (e.g., as part of block 712 with reference to FIG. 7).

In block 902, the processing system may receive a phase-vector (e.g., created as described in method 800 with reference to FIG. 8). For example, the processor may retrieve the phase-vector from a direct-memory-access engine that transfers double-precision values created during an earlier initialization routine into an on-chip register file.

In block 904, the processing system may determine whether there is an unprocessed phase-vector value. For example, the processor may compare a loop counter with a length field stored in the phase-vector header to decide whether additional entries require processing.

In response to determining that there is an unprocessed phase-vector value (i.e., determination block 904=“Yes”), then in block 906 the processing system may select the unprocessed phase-vector value. For example, the processor may load the next phase-vector element into a scalar register and mark its index as processed inside a bit-mask array.

Blocks 908-912 may prepare the phase-vector value for vector rotation (by vector rotation component 310, 360 with reference to FIG. 3A, 3B) by mapping it to range −π to π. In block 908, the processing system may update the phase-vector value by calculating the modulus of the phase-vector value when divided by 2π. For example, the processor may execute a fused multiply-add sequence that evaluates phase_value−floor(phase_value/(2·π))·2·π, which constrains the value to the primary interval.

In block 910, the processing system may determine whether the phase-vector value is greater than π. For example, the processor may compare the constrained value with a π constant held in a vector register and set a flag when the value exceeds that constant.

In response to determining that the phase-vector value is greater than π (i.e., determination block 910=“Yes”), then in block 912 the processing system may update the phase-vector value by subtracting 2π from phase-vector value. For example, the processor may perform a conditional subtract that deducts 2π from the flagged value and writes the adjusted quantity back to the working register.

Blocks 914-920 may quantize the phase-vector value to the bit precision of the hardware (e.g., a 16 bit architecture would have a bit precision of 16 (“BitPrecision”=16), a 32 bit architecture would have a bit precision of 32 (“BitPrecision”=32)). In block 914, the processing system may update the phase-vector value by multiplying it by 2^{BitPrecision-3}. (BitPrecision−3) is used rather than BitPrecision because the modulus output values (e.g., blocks 908-912) may be as high as π=3.1415. For example, the processor may shift the value left by (BitPrecision−3) fractional bits through a hardware multiplier that accepts floating-point format input and outputs fixed-point format.

In block 916, the processing system may round the phase-vector value to the nearest integer. For example, the processor may invoke a round-to-nearest-even instruction to convert the scaled fixed-point value into an integer suitable for quantization.

In block 918, the processing system may determine whether the phase-vector value is negative. For example, the processor may inspect the most-significant bit of the integer and raise a branch flag when that bit equals one, which denotes a negative quantity in two-complement representation.

In response to determining that the phase-vector value is negative (i.e., determination block 918=“Yes”), then in block 920 the processing system may update the phase-vector value by adding 2^{BitPrecision} to the phase-vector value. For example, the processor may add 2^{BitPrecision} to any negative integer through a saturated-add instruction so that the value becomes an unsigned coefficient

Blocks 922-924 may convert the phase-vector value to the numeral system of the hardware. In block 922, the processing system may convert the phase-vector value to a hexadecimal phase-vector value. For example, the processor may format the integer into a fixed-width hexadecimal string by indexing a nibble-to-ASCII lookup table and store the string inside a temporary buffer.

In block 924, the processing system may replace the phase-vector value in the phase-vector with the hexadecimal phase-vector value. For example, the processor may overwrite the original element in the phase-vector array with the hexadecimal representation and increment an element pointer.

In response to determining that there is not an unprocessed phase-vector value (i.e., determination block 904=“No”), then in block 926 the process may exit, end, terminate, or finish. For example, the processor may clear working registers and return control to a scheduler routine once the loop flag indicates that no additional values remain.

In the various embodiments, blocks 908-924 may be adjusted based upon the features of the specific hardware platform. Further, some of blocks 908-924 may not be needed, and additional blocks may be included. For example, a sixteen-bit micro-controller platform may omit the hexadecimal conversion and directly store rounded integers, whereas a thirty-two-bit digital-signal processor may insert an extra normalisation pass to match an internal Q-format.

In the various embodiments, the methods described herein may be used to provide a low complexity and low latency solution to compensate the phase discontinuity in 5G NR OFDM symbols. The methods described herein may be implemented in base stations radios (e.g., 5G gNBs) and, or mobile devices (e.g., 5G UEs). An advantage of the low complexity of the methods described herein is that they may consume less power when implemented compared to previous methods.

In the various embodiments, the methods described herein may be independent of the range of frequencies being used. Further, the methods described herein may provide a universal solution and that works for all frequencies within a 5G NR numerology (e.g., FR1, FR2).

Various embodiments include methods executed by a processing system included in a radio device for compensating for compensating symbol-to-symbol phase discontinuity introduced by a gNB center frequency, the method which may include receiving, by the processing system, a gNB center-frequency parameter and a subcarrier-spacing parameter, constructing, by the processing system, a symbol-timing table in a memory that maps each OFDM (OFDM) symbol index to a symbol-end-time value according to the subcarrier-spacing parameter, calculating, by the processing system, a phase vector that may include a plurality of phase values, each phase value equal to 2·π·(the gNB center-frequency parameter)·(the symbol-end-time value) mapped to a corresponding OFDM symbol index, and storing the phase vector in the memory at an address directly accessible to a vector-rotation circuit included in reconfigurable hardware coupled to the memory, for each OFDM symbol in a stream of complex time-domain samples processed by the reconfigurable hardware retrieving, by the vector-rotation circuit, a selected phase value from the phase vector according to a current OFDM symbol index, generating, by the vector-rotation circuit, a cosine component and a sine component that correspond to the selected phase value, rotating, by a complex multiplier included in the reconfigurable hardware, the OFDM symbol by the cosine component and the sine component to form a phase-compensated symbol, and outputting the phase-compensated symbol.

Some embodiments may further include determining a bit precision value (N), mapping each phase value into an interval greater than −π and less than or equal to +π, quantizing each mapped phase value by multiplying the mapped phase value by 2^{(N-3)}, rounding the product to a nearest integer, and adding 2N to any rounded integer that may be negative to form a fixed-point phase vector of bit precision N. In some embodiments, the vector-rotation circuit may include a coordinate-rotation-digital-computer engine that, responsive to the fixed-point phase vector, generates the cosine component and the sine component within one hardware clock cycle. In some embodiments, determining the bit precision value (N) may include selecting N from a set that may include eight-bit precision and sixteen-bit precision according to a capability of the reconfigurable hardware. In some embodiments, the rotating occurs after cyclic-prefix insertion when the radio device operates as a transmitter and after cyclic-prefix removal when the radio device operates as a receiver. In some embodiments, constructing the symbol-timing table further may include, for each OFDM symbol index, summing a symbol-start-time value and a guard-time value, the guard-time value equal to a product of a guard-period value and a unit-time value derived from the subcarrier-spacing parameter. In some embodiments, the symbol-timing table repeats with a period of fourteen OFDM symbol indices when the subcarrier-spacing parameter corresponds to numerology equal to zero or one. Some embodiments may further include updating the symbol-timing table and the phase vector during operation responsive to a measured change in channel delay spread without interrupting OFDM symbol processing. In some embodiments, mapping each phase value may include performing a modulus-2π operation. In some embodiments, multiplying the mapped phase value and rounding the product may include executing fixed-point arithmetic instructions in the processing system. In some embodiments, the processing system and the reconfigurable hardware may reside on a single system-on-chip. In some embodiments, the downstream signal-processing stage may include an Ethernet-based fronthaul interface when the radio device operates inside an open radio-access-network radio unit.

The embodiments include methods of phase pre-compensation in a transmit path of an OFDM radio module, performed by at least one processing circuit, the method which may include receiving a generic phase vector that contains a sequence of floating-point phase values, selecting a bit-precision value N that defines a target fixed-point numeric format, for each phase value in the generic phase vector, computing a remainder of the phase value modulo 2π so that the remainder lies in an interval greater than −π and less than or equal to +π, multiplying the remainder by 2^{(N-3)} to obtain a scaled phase value, rounding the scaled phase value to a nearest integer to obtain a rounded phase value, and responsive to determining the rounded phase value may be negative, adding 2N to produce an unsigned fixed-point coefficient, writing each unsigned fixed-point coefficient to successive memory locations to form a hardware-ready phase vector directly addressable by a vector-rotation circuit for each OFDM symbol to be transmitted, selecting a fixed-point coefficient from the hardware-ready phase vector, generating by the vector-rotation circuit a corresponding cosine value and sine value within one hardware clock cycle, and multiplying the OFDM symbol by the cosine and sine values to produce a phase-compensated OFDM symbol for transmission, in which successive phase-compensated OFDM symbols exhibit continuous phase transitions across symbol boundaries.

In some embodiments, computing the remainder of the phase value modulo 2π further may include subtracting 2π from the phase value in response to the remainder exceeding π, thereby confining the remainder to said interval before multiplying the remainder by 2^{(N-3)}. Some embodiments may further include formatting each unsigned fixed-point coefficient as a hexadecimal value and replacing a corresponding floating-point element in the generic phase vector with the hexadecimal value prior to writing the unsigned fixed-point coefficient to the memory locations that form the hardware-ready phase vector. In some embodiments, the bit-precision value N may be selected from a range of 8 to 32 bits inclusive, based on a supported fixed-point precision of hardware associated with the vector-rotation circuit. In some embodiments, the receiving, selecting, and writing operations are performed during an initialization interval that precedes baseband data transmission, such that the hardware-ready phase vector may be prepared before live OFDM traffic begins.

Some embodiments may further include repeating the receiving, selecting, converting, and writing operations for each subcarrier spacing parameter in a plurality of subcarrier spacing parameters, and storing in memory a distinct hardware-ready phase vector for each subcarrier spacing parameter to support multiple OFDM numerologies. In some embodiments, the method may be implemented in a 5G New Radio (NR) wireless communication system, and the hardware-ready phase vector provides phase adjustments for successive OFDM symbols in accordance with a 5G NR frame structure.

Some embodiments may further include an input buffer configured to hold a generic phase vector which may include floating-point phase values, a precision selector configured to store a bit-precision value N that defines a target fixed-point numeric format, a conversion logic circuit, coupled to the input buffer and the precision selector, configured to, for each phase value held in the input buffer compute a remainder of the phase value modulo 2π so that the remainder lies in an interval greater than −π and less than or equal to +π, multiply the remainder by 2^{(N-3)} to obtain a scaled phase value, round the scaled phase value to a nearest integer to obtain a rounded phase value, and when the rounded phase value may be negative, add 2^{N} to produce an unsigned fixed-point coefficient, a vector memory that stores the successive unsigned fixed-point coefficients output by the conversion logic circuit, thereby forming a hardware-ready phase vector directly addressable by a vector-rotation circuit, a vector-rotation circuit, coupled to the vector memory, configured to read a selected fixed-point phase coefficient from the hardware-ready phase vector and generate a corresponding cosine value and sine value within a single hardware clock cycle, and a phase-compensation multiplier, coupled to the vector-rotation circuit, configured to multiply a baseband OFDM symbol by the cosine value and the sine value to produce a phase-compensated OFDM symbol for transmission with continuous phase relative to preceding symbols.

In some embodiments, the conversion logic circuit may include a comparator configured to detect when the remainder exceeds π and, in response, subtract 2π from the remainder before the remainder may be multiplied by 2^{(N-3)}. Some embodiments may further include a formatter configured to convert each unsigned fixed-point coefficient to a hexadecimal representation and to overwrite the corresponding floating-point phase value in the input buffer with the hexadecimal representation prior to storage of that coefficient in the vector memory. In some embodiments, the precision selector may be configured to select the bit-precision value N from a range of 8 to 32 bits based on a supported numeric precision of an associated hardware platform for the vector-rotation circuit. In some embodiments, the vector-rotation circuit may output the cosine and sine values for each selected phase coefficient within one hardware clock cycle. In some embodiments, the input buffer, the precision selector, the conversion logic circuit, and the vector memory may be configured to operate during an initialization interval that precedes transmission of baseband OFDM data, such that the hardware-ready phase vector may be loaded before any OFDM symbols are transmitted. In some embodiments, the input buffer, the precision selector, and the conversion logic circuit are further configured to repeat their operations for each subcarrier spacing among a plurality of subcarrier spacing parameters, and in which the vector memory stores a respective hardware-ready phase vector for each of the plurality of subcarrier spacing parameters. In some embodiments, the apparatus may be integrated in a 5G New Radio (NR) base station radio unit and the hardware-ready phase vector may be generated to compensate phase discontinuities according to 5G NR numerology and frame timing.

Further embodiments may include a computing device having a processor configured with processor-executable instructions to perform various operations corresponding to the methods discussed above. Further embodiments may include a computing device having various means for performing functions corresponding to the method operations discussed above. Further embodiments may include a non-transitory processor-readable storage medium having stored thereon processor-executable instructions configured to cause a processor to perform various operations corresponding to the method operations discussed above.

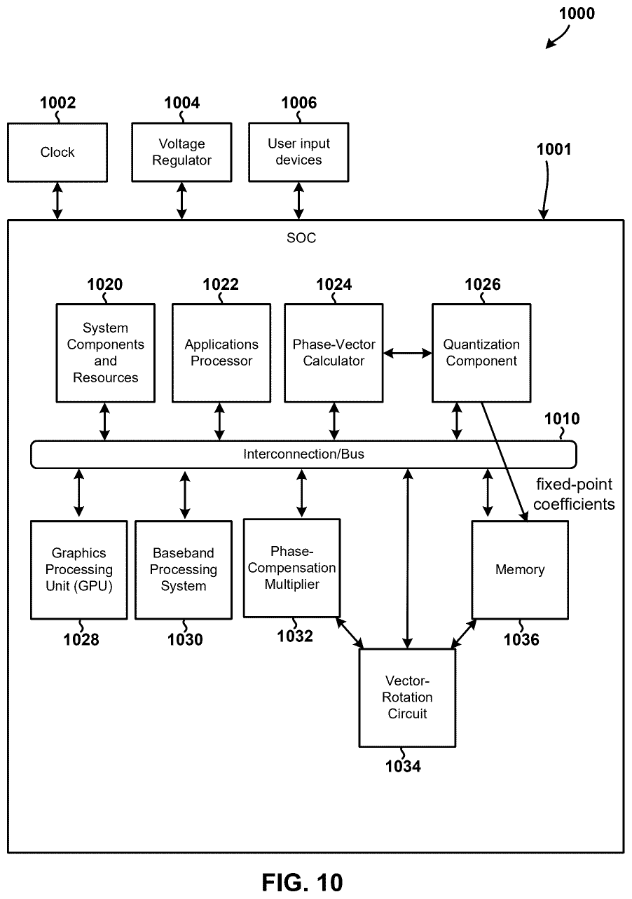

Various embodiments may run on single-processor or multiprocessor computing platforms that include SoC or SiP configurations. FIG. 10 illustrates an example processing or computing system 1000 that could be configured to implement some embodiments. In the example illustrated in FIG. 10, the system 1000 includes a clock 1002, voltage regulator 1004, user input devices 1006, system components and resources 1020, applications processor 1022, phase-vector calculator 1024, quantization component 1026, graphics processing unit (GPU) 1028, baseband processing system 1030, phase-compensation multiplier 1032, vector-rotation circuit 1034, and memory 1036. The processors and components may be interconnected via an interconnection/bus 1010, which may utilize advanced interconnect technologies such as high-performance networks-on-chip (NoCs), reconfigurable logic arrays, or bus architectures like CoreConnect or AMBA.

In some embodiments, the memory 1036 may include a vector memory (not illustrated separately). In some embodiments, the baseband processing system 1030 may include the reconfigurable hardware 304, 354 illustrated and described with reference to FIGS. 3A-B. In some embodiments, the phase-vector calculator 1024 may include the phase-vector calculator 306, 356 illustrated and described with reference to FIGS. 3A-B. In some embodiments, the quantization component 1026 may include the quantization component 318, 368 illustrated and described with reference to FIGS. 3A-B. In some embodiments, the vector-rotation circuit 1034 may include the vector rotation component 310, 360 illustrated and described with reference to FIGS. 3A-B.

Processors within SoC 1000 may function as central processing units (CPU), microprocessor units (MPU), or arithmetic logic units (ALU). The SoC may execute program instructions that direct arithmetic, logical, control, and input-output operations. One or more coprocessors may assist the CPU and may implement hardware acceleration for phase-vector calculator 1024 or quantization component 1026. Each processor may include multiple cores, and each core may perform operations independent from other cores. For example, one core may run a real-time operating system that manages baseband processing system 1030 while another core may run a general-purpose operating system that supports user-level applications.

The clock 1002 may be configured to generate a stable timing reference that aligns operation of all synchronous circuits in the system 1000. The voltage regulator 1004 may be configured to supply a regulated direct-current voltage that matches design voltage levels of on-chip circuits and peripheral components. The user input devices 1006 may be configured to capture user commands and forward corresponding digital control signals to the applications processor 1022.

The system components and resources 1020 may be configured to manage auxiliary functions that include security management power sequencing and peripheral control. The applications processor 1022 may be configured to execute operating-system routines and user application code that coordinate high-layer communication tasks. The phase-vector calculator 1024 may be configured to accept a generic phase vector to select a bit-precision value N and to produce intermediate data for quantization. The quantization component 1026 may be configured to perform modulus reduction scaling rounding and offset addition to convert each floating-point phase value into an unsigned fixed-point coefficient. The graphics processing unit 1028 may be configured to accelerate rasterization shading and display composition tasks for graphical user interfaces. The baseband processing system 1030 may be configured to execute modulation demodulation coding decoding and filtering operations that form physical-layer transmit and receive chains. The phase-compensation multiplier 1032 may be configured to multiply each orthogonal-frequency-division-multiplexing symbol by cosine and sine values supplied by the vector-rotation circuit 1034 to maintain phase continuity across symbols. The vector-rotation circuit 1034 may be configured to read fixed-point coefficients from the memory 1036 and to generate corresponding cosine and sine values within one hardware clock cycle. The memory 1036 may be configured to store program instructions and configuration data and a hardware-ready phase vector that the vector-rotation circuit 1034 accesses during live traffic.

The SoC may include various additional system components and resources, such as for managing sensor data, wireless transmissions, analog-to-digital conversions, power amplification, voltage regulation, frequency synthesis, data control, memory access, and peripheral bridging for radio operation. These components may include power amplifiers, voltage regulators, oscillators, phase-locked loops, data controllers, memory controllers, and bridges that interface with cameras, microphones, external displays, and wireless transceiver modules.

The SoC may further include an input/output (I/O) module (not illustrated) for interfacing with external resources such as the clock 1002, voltage regulator 1004, user input devices 1006, and and external wireless transceivers such as Bluetooth or cellular radio units. Multiple processors or cores within the SoC 1000 may share these external resources through a common bus architecture.

In addition to the SoC 1000, various embodiments may be implemented in other computing systems. Alternative computing platforms may host the phase-vector calculator quantization component vector memory vector-rotation circuit and phase-compensation multiplier described above. A single-core processor a multicore processor or a heterogeneous hybrid configuration may therefore execute the disclosed functionality without departure from the scope of the present embodiments.

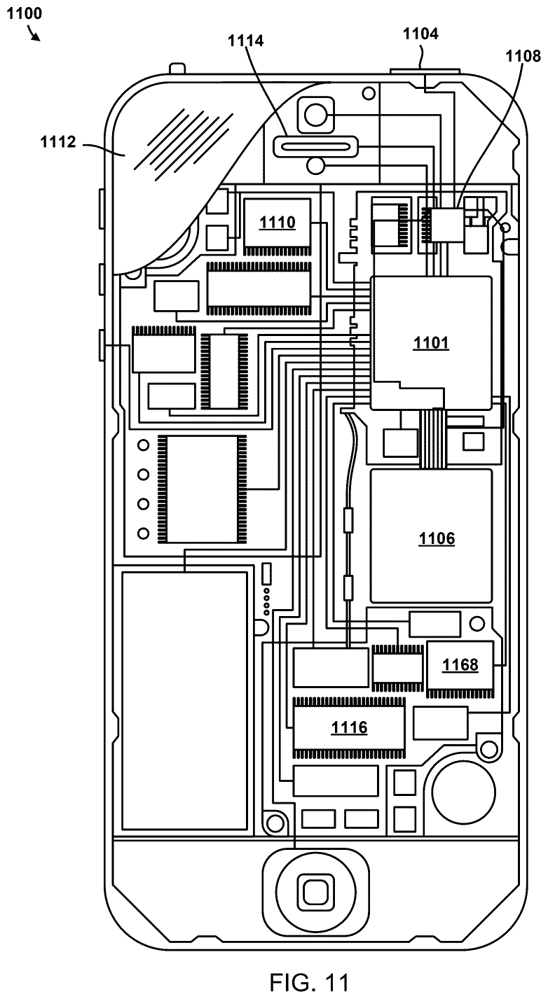

The various embodiments may be implemented on a variety of computing devices, an example of which is illustrated in FIG. 11 in the form of a smartphone. A smartphone 1100 may include a SOC 1101 (or SOC 1001, etc.) that includes processors (e.g., application processor, modem processor, graphics processor, etc.) and is coupled to internal memory 1106, a display 1112, and to a speaker 1114. Additionally, the smartphone 1100 may include an antenna 1104 for sending and receiving electromagnetic radiation that may be connected to a wireless data link and/or cellular telephone transceiver 1108 coupled to one or more processors of the SOC 1101. A typical smartphone 1100 also includes a sound encoding/decoding (CODEC) circuit 1110, which digitizes sound received from a microphone into data packets suitable for wireless transmission and decodes received sound data packets to generate analog signals that are provided to the speaker to generate sound. Also, one or more of the processors in the SOC 1101, transceiver 1108, and/or CODEC circuit 1110 may include a digital signal processor (DSP) circuit (not shown separately).

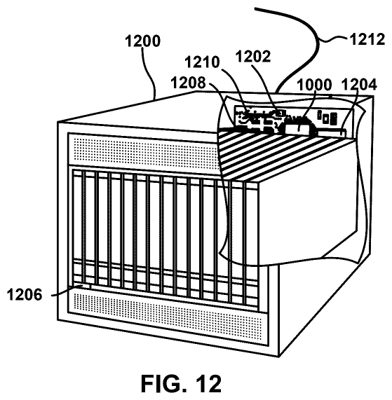

All or portions of some embodiments may be implemented in the cloud or on a variety of commercially available computing devices, such as the server computing device 1200 illustrated in FIG. 12. The server device 1200 may include a SoC 1001, 1101 or one or more processors 1102 (e.g., multi-core processor, etc.) coupled to memory 1104, storage interfaces 1106 such as USB ports and NVMe slots, and network access ports 1108 that allow data connections through a network interface card (NIC) 1110 and a communication network 1112 (e.g., an Internet Protocol (IP) network) connected to other network elements.

For the sake of clarity and ease of presentation, the methods discussed in this application are presented as separate embodiments. While each method is delineated for illustrative purposes, it should be clear to those skilled in the art that various combinations or omissions of these methods, blocks, operations, etc. could be used to achieve a desired result or a specific outcome. It should also be understood that the descriptions herein do not preclude the integration or adaptation of different embodiments of the methods, blocks, operations, etc. from producing a modified or alternative result or solution. The presentation of individual methods, blocks, operations, etc. should not be interpreted as mutually exclusive, limiting, or as being required unless expressly recited as such in the claims.

The processors discussed in this application may be any programmable microprocessor, microcomputer, or a combination of multiple processor chips configured by software instructions (applications) to perform diverse functions, including those of the various embodiments described herein. Severs 900 often include multiple processors, with dedicated processors for specific tasks such as managing cloud computing operations, data analytics, or wireless communication functions. Software applications may be stored in the internal memory before being accessed and executed by the processor. Modern processors may include extensive internal memory, often augmented with fast access cache memory, to efficiently store and process application software instructions.

As used in this application, terminology such as “component,” “module,” “system,” etc., is intended to encompass a computer-related entity. These entities may involve, among other possibilities, hardware, firmware, a blend of hardware and software, software alone, or software in an operational state. As examples, a component may encompass a running process on a processor, the processor itself, an object, an executable file, a thread of execution, a program, or a computing device. To illustrate further, both an application operating on a computing device and the computing device itself may be designated as a component. A component might be situated within a single process or thread of execution or could be distributed across multiple processors or cores. In addition, these components may operate based on various non-volatile computer-readable media that store diverse instructions and/or data structures. Communication between components may take place through local or remote processes, function, or procedure calls, electronic signaling, data packet exchanges, memory interactions, among other known methods of network, computer, processor, or process-related communications.

A variety of memory types and technologies, both currently available and anticipated for future development, may be incorporated into systems and computing devices that implement the various embodiments. These memory technologies may include non-volatile random-access memories (NVRAM) such as magnetoresistive RAM (MRAM), resistive random-access memory (ReRAM or RRAM), phase-change memory (PCM, PC-RAM, or PRAM), ferroelectric RAM (FRAM), spin-transfer torque magnetoresistive RAM (STT-MRAM), and three-dimensional cross point (3D XPoint) memory. Non-volatile or read-only memory (ROM) technologies may also be included, such as programmable read-only memory (PROM), field programmable read-only memory (FPROM), and one-time programmable non-volatile memory (OTP NVM). Volatile random-access memory (RAM) technologies may further be utilized, including dynamic random-access memory (DRAM), double data rate synchronous dynamic random-access memory (DDR SDRAM), static random-access memory (SRAM), and pseudostatic random-access memory (PSRAM). Additionally, systems and computing devices implementing these embodiments may use solid-state non-volatile storage mediums, such as FLASH memory. The aforementioned memory technologies may store instructions, programs, control signals, and/or data for use in computing devices, system-on-chip (SoC) components, or other electronic systems. Any references to specific memory types, interfaces, standards, or technologies are provided for illustrative purposes and do not limit the claims to any particular memory system or technology unless explicitly recited in the claim language.

The foregoing method descriptions and the process flow diagrams are provided merely as illustrative examples and are not intended to require or imply that the blocks of the various aspects must be performed in the order presented. As may be appreciated by one of skill in the art the order of steps in the foregoing aspects may be performed in any order. Words such as “thereafter,” “then,” “next,” etc. are not intended to limit the order of the blocks; these words are simply used to guide the reader through the description of the methods. Further, any reference to claim elements in the singular, for example, using the articles “a,” “an” or “the” is not to be construed as limiting the element to the singular.

The various illustrative logical blocks, modules, circuits, and algorithmic steps described in connection with the aspects disclosed herein may be implemented as electronic hardware, computer software, or combinations of both. To clearly illustrate the interchangeability of hardware and software, various components, blocks, modules, circuits, and steps have been described in terms of their functionality. Whether such functionality is implemented as hardware or software may depend on the specific application and the design constraints of the overall system. Skilled artisans may implement the described functionality in different ways for each particular application, and such implementation decisions should not be interpreted as limiting or altering the scope of the claims unless explicitly recited in the claim language.

The hardware used to implement the various illustrative logics, logical blocks, modules, and circuits described in connection with the embodiments disclosed herein may include or be performed by a general-purpose processor, a digital signal processor (DSP), an application-specific integrated circuit (ASIC), a field-programmable gate array (FPGA), a graphics processing unit (GPU), a tensor processing unit (TPU), or other programmable logic devices, discrete gate or transistor logic, discrete hardware components, or any combination thereof, designed to perform the functions described. A general-purpose processor may be a microprocessor, or alternatively, it may be any conventional processor, controller, microcontroller, or state machine. A processor may also be implemented as a combination of computing devices, such as a DSP combined with a microprocessor, multiple microprocessors, one or more microprocessors used in conjunction with a DSP core, a GPU, or AI accelerators such as TPUs. Alternatively, some operations or methods may be performed by circuitry designed specifically for a given function.

In one or more embodiments, the functions described may be implemented in hardware, software, firmware, or any combination thereof. If implemented in software, the functions may be stored as one or more instructions or code on a non-transitory computer-readable medium or non-transitory processor-readable medium. The operations of a method or algorithm disclosed herein may be embodied in a processor-executable software module that resides on a non-transitory computer-readable or processor-readable storage medium. Non-transitory computer-readable or processor-readable storage media include any storage media that may be accessed by a computer or processor. By way of example, but not limitation, such non-transitory computer-readable or processor-readable media may include RAM, ROM, EEPROM, flash memory, SSDs, NVMe drives, 3D NAND flash, or any other medium capable of storing program code in the form of instructions or data structures that may be accessed by a computer. Cloud-based storage solutions, including infrastructure-as-a-service (IaaS) platforms, may provide scalable and distributed options for storing and accessing program code. In addition, the operations of a method or algorithm may reside as one or more sets of instructions or code on a non-transitory processor-readable or computer-readable medium, which may be incorporated into a computer program product. Emerging technologies, such as quantum computing storage media and blockchain-based storage solutions, may enhance data integrity and security. AI and ML-improved hardware accelerators, such as GPUs, TPUs, and other dedicated processing units, may be used to efficiently execute complex algorithms.

The preceding description of the disclosed aspects is provided to enable any person skilled in the art to make or use the claims. Various modifications to these aspects may be apparent to those skilled in the art, and the generic principles defined herein may be applied to other aspects without departing from the scope of the claims. Thus, the present disclosure is not intended to be limited to the aspects shown herein but is to be accorded the widest scope consistent with the following claims and the principles and novel features disclosed herein.

What is claimed is:

1. A method for phase pre-compensation, performed by at least one processor of a processing system in a radio device, the method comprising:
receiving a generic phase vector that contains floating-point phase values;
selecting a bit-precision value N that defines a target fixed-point numeric format;
for each phase value in the generic phase vector:
computing a remainder of the phase value mod 2π to map the phase value to an interval greater than −π and less than or equal to +π;
multiplying the remainder by 2^{(N-3)} to obtain a scaled phase value;
rounding the scaled phase value to a nearest integer to obtain a rounded phase value; and
adding 2^{N} to produce an unsigned fixed-point coefficient in response to determining that the rounded phase value is negative; and
writing each unsigned fixed-point coefficient to successive memory locations to form a hardware-ready phase vector directly addressable by a vector-rotation circuit.

2. The method of claim 1, wherein computing the remainder of the phase value mod 2π to map the phase value to an interval greater than −π and less than or equal to +π further comprises subtracting 2π before multiplying the remainder by 2^{(N-3)} to obtain the scaled phase value in response to determining that the remainder exceeds π.

3. The method of claim 1, further comprising formatting the unsigned fixed-point coefficient as a hexadecimal string and replacing the corresponding floating-point element in the generic phase vector with the hexadecimal string before writing each unsigned fixed-point coefficient to successive memory locations that together form the hardware-ready phase vector directly addressable by the vector-rotation circuit.

4. The method of claim 1, further comprising selecting the bit-precision value N from a set that includes 8, 12, 16, and 32 according to a capability of a reconfigurable hardware platform associated with the vector-rotation circuit.

5. The method of claim 1, further comprising transferring the hardware-ready phase vector through an interface to the vector-rotation circuit, the vector-rotation circuit generating cosine and sine components from the hardware-ready phase vector within a single hardware clock cycle.

6. The method of claim 1, wherein the operations of receiving the generic phase vector, selecting the bit-precision value N, and writing each unsigned fixed-point coefficient to successive memory locations are performed during an initialization interval that precedes base-band data transmission or reception.

7. The method of claim 1, further comprising repeating the operations of receiving the generic phase vector, selecting the bit-precision value N, and writing each unsigned fixed-point coefficient to successive memory locations for each sub-carrier-spacing parameter in a plurality of sub-carrier-spacing parameters and storing a corresponding hardware-ready phase vector for each sub-carrier-spacing parameter in the memory.

8. The method of claim 1, wherein multiplying the remainder by 2^{(N-3)} to obtain the scaled phase value comprises left-shifting the remainder by (N−3) fractional bits in a hardware multiplier that accepts floating-point input and outputs fixed-point format.

9. The method of claim 1, further comprising for each OFDM symbol to be transmitted:
selecting a fixed-point coefficient from the hardware-ready phase vector,
generating by the vector-rotation circuit a corresponding cosine value and sine value within one hardware clock cycle, and
multiplying the OFDM symbol by the cosine and sine values to produce a phase-compensated OFDM symbol for transmission,
wherein successive phase-compensated OFDM symbols exhibit continuous phase transitions across symbol boundaries.

10. A phase-vector quantizer circuit, comprising:
an input buffer configured to hold a generic phase vector that contains floating-point phase values;
a precision selector configured to store a bit-precision value N that defines a target fixed-point numeric format;
a conversion logic block, coupled to the input buffer and the precision selector, the conversion logic block being configured, for each phase value held in the input buffer, to:
compute a remainder of the phase value modulo 2π so that the remainder lies in an interval greater than −π and less than or equal to +π;
multiply the remainder by 2^{(N-3)} to obtain a scaled phase value;
round the scaled phase value to a nearest integer to obtain a rounded phase value;
add 2^{N} to produce an unsigned fixed-point coefficient in response to determining the rounded phase value is negative; and
a vector memory that stores successive unsigned fixed-point coefficients produced by the conversion logic block so as to form a hardware-ready phase vector directly addressable by a vector-rotation circuit.

11. The phase-vector quantizer circuit of claim 10, further comprising a vector-rotation circuit, coupled to the vector memory, configured to read a selected fixed-point phase coefficient from the hardware-ready phase vector and generate a corresponding cosine value and sine value within a single hardware clock cycle; and
a phase-compensation multiplier, coupled to the vector-rotation circuit, configured to multiply a baseband OFDM symbol by the cosine value and the sine value to produce a phase-compensated OFDM symbol for transmission with continuous phase relative to preceding symbols.

12. The phase-vector quantizer circuit of claim 10, wherein the conversion logic block further comprises a comparator configured to detect whether the remainder exceeds π and subtract 2π from the remainder before obtaining the scaled phase value in response to detecting that the remainder exceeds I.

13. The phase-vector quantizer circuit of claim 10, further comprising a formatter coupled to the vector memory and configured to convert each unsigned fixed-point coefficient to a hexadecimal string and overwrite a corresponding floating-point element in the generic phase vector with the hexadecimal string before storage in the vector memory.

14. The phase-vector quantizer circuit of claim 10, wherein the precision selector is configured to select the bit-precision value N from a set that includes 8, 12, 16, and 32 according to a capability of a reconfigurable hardware platform associated with the vector-rotation circuit.

15. The phase-vector quantizer circuit of claim 10, further comprising an interface controller that transfers the hardware-ready phase vector from the vector memory to the vector-rotation circuit, the vector-rotation circuit generating cosine and sine components from the hardware-ready phase vector within a single hardware clock cycle.

16. The phase-vector quantizer circuit of claim 10, wherein the input buffer, the precision selector, and the conversion logic block are configured to operate during an initialization interval that precedes base-band data transmission or reception.

17. The phase-vector quantizer circuit of claim 10, wherein the input buffer, the precision selector, and the conversion logic block are further configured to repeat their respective operations for each sub-carrier-spacing parameter in a plurality of sub-carrier-spacing parameters and to store a corresponding hardware-ready phase vector for each sub-carrier-spacing parameter in the vector memory.

18. The phase-vector quantizer circuit of claim 10, wherein the conversion logic block is further configured to multiply the remainder by 2^{(N-3)} to obtain a scaled phase value by left-shifting the remainder by (N−3) fractional bits in a hardware multiplier that accepts floating-point input and produces fixed-point output.

19. The phase-vector quantizer circuit of claim 10, wherein the conversion logic block is further configured to, for each OFDM symbol to be transmitted:
select a fixed-point coefficient from the hardware-ready phase vector,
generate by the vector-rotation circuit a corresponding cosine value and sine value within one hardware clock cycle, and
multiply the OFDM symbol by the cosine and sine values to produce a phase-compensated OFDM symbol for transmission,
wherein successive phase-compensated OFDM symbols exhibit continuous phase transitions across symbol boundaries.

20. A computing device, comprising:
a memory;
a vector-rotation circuit; and
a processing system coupled to the memory and the vector-rotation circuit and configured to:
receive a generic phase vector that contains floating-point phase values;
store in the memory a bit-precision value N within a range from eight through thirty-two bits;
for each phase value in the generic phase vector, perform:
compute a remainder of the phase value modulo 2π lying in an interval greater than −π and less than or equal to +π;
multiply the remainder by 2^{(N-3)} to form a scaled phase value;
round the scaled phase value to a nearest integer to form a rounded phase value;
add 2^{N} to produce an unsigned fixed-point coefficient in response to determining the rounded phase value has a negative sign;
write successive unsigned fixed-point coefficients to contiguous memory locations to form a hardware-ready phase vector addressable by the vector-rotation circuit; and
for each orthogonal frequency division multiplexing (OFDM) symbol prior to transmission, select a fixed-point coefficient from the hardware-ready phase vector, direct the vector-rotation circuit to generate a cosine value and a sine value responsive to the fixed-point coefficient within one hardware clock cycle, and multiply the OFDM symbol by the cosine value and the sine value to produce a phase-compensated OFDM symbol that maintains phase continuity relative to a preceding OFDM symbol.
